(19) United States
(12) Patent Application Publication
(10) Pub. No.: US 2022/0082840 A1
(43) Pub. Date: Mar. 17, 2022

(54) GLASS ARTICLE WITH LOW OPTICAL LOSS

(71) Applicant: Schott AG, Mainz (DE)

(72) Inventors: Peter Naß, Mainz (DE); Hubertus Russert, Jugenheim (DE); Thorsten Damm, Eltville am Rhein (DE); Volker Plapper, Alzey (DE); Antoine Carré, Mainz (DE); Jens Ulrich Thomas, Mainz (DE)

(73) Assignee: Schott AG, Mainz (DE)

(21) Appl. No.: 17/474,888

(22) Filed: Sep. 14, 2021

(30) Foreign Application Priority Data
Sep. 14, 2020 (DE) 10 2020 123 828.2

(51) Int. Cl. G02B 27/01; G02B 27/00; F21V 8/00

(52) U.S. Cl. CPC G02B 27/0172; G02B 2027/0178; G02B 6/0016; G02B 27/0081

(57) ABSTRACT

The present invention relates to a glass article with low optical loss. The present invention also relates to the use of the glass article, in particular as optical waveguide, for example as light guide plate, in particular in augmented reality devices.

### CROSS REFERENCE TO RELATED APPLICATIONS

This application claims priority to German Patent Application No. DE 10 2020 123 828.2 filed on Sep. 14, 2020, which is incorporated in its entirety herein by reference.

### BACKGROUND OF THE INVENTION

### 1. Field of the Invention

The present invention relates to a glass article with low optical loss. The present invention also relates to the use of the glass article, in particular as an optical waveguide, for example as a light guide plate, in particular in augmented reality devices.

### 2. Description of the Related Art

Augmented reality (AR) is used for displaying computer-generated perceptual information, in particular visual information, concerning objects residing in the real world.

AR devices have recently gained increased importance. In particular, AR displays can be rendered on devices resembling eyeglasses. Such AR devices may display computer-generated visual information projected through or reflected off the surfaces of the lens pieces of the devices. Optical waveguides are a necessary component for the most of such AR devices. In particular, optical waveguides may be provided as light guide plates. Generally, light guide plates are planar wafer-like structures that are used for transmitting light. Thus, light is fed into the light guide plate in one position, is transmitted through the light guide plate and leaves the light guide plate at another position. More precisely, the plate has to guide not only light but also an image, i.e. the light paths may not mix up between in-coupling and out-coupling positions. Notably, the distance that the light travels through the light guide plate is often comparably high and may easily be several cm. In view of the above, light guide plates with low optical loss are desired. Such light guide plates should also have low weight in order to increase wear comfort, in particular in case of eyeglasses.

Optical waveguides such as light guide plates are known. However, a problem with current optical waveguides is that they have comparably high optical losses. One has to distinguish between absorption and scattering loss. If absorption losses are too high, a strong signal has to be fed into the light guide plates in order to compensate the absorption loss so that there need to be larger batteries and batteries have to be recharged more often. Moreover, high power light source may be associated with generation of heat so that a complex temperature management is required. Contrast and/or resolution may be impaired by increased scattering losses. Furthermore, image quality is compromised as well. In particular, there may heterogeneous brightness profiles if the dependence of the total optical loss from the propagation angle is too large. Moreover, current devices are comparably thick and heavy.

What is needed in the art is a way to provide optical waveguides that overcome at least some of the problems of the prior art.

### SUMMARY OF THE INVENTION

In some exemplary embodiments provided according to the present invention, a glass article includes a glass having a fracture toughness K_{Ic} of more than 0.4 MPa·√m. The glass article has an article thickness d. The glass article is characterized by an optical loss α upon propagation of light having a wavelength of 450 nm inside the glass article based on total internal reflection at a propagation angle θ formed between a normal to a surface of the glass article and a propagation direction of the light approaching the surface. The optical loss α is determined by moving an optical fiber across the surface of the glass article in a direction of the propagating light beam and along the way detecting the light which was scattered and thereby left the glass article at different lateral path positions xᵢ of the optical fiber over a lateral path distance of the optical fiber of at least 2 cm. The optical loss α is determined by the formula

$$α = \frac{ln ( {I}_{2} ) - ln ( {I}_{1} )}{{OP}_{2} - {OP}_{1}} .$$

I₂ and I₁ are light intensities at lateral path positions x₂ and x₁, respectively, of the optical fiber determined based on ln(I₂)=f(x₂) and ln(I₁)=f(x₁), respectively, with f(x) being the least squares linear regression describing the dependence of the natural logarithm of the detected light intensity from the lateral path position x of the optical fiber. OP₂ and OP₁ are optical path positions corresponding to the lateral path positions x₂ and x₁, respectively, with OP₂ and OP₁ determined as OP₂=x₂/sin(θ) and OP₁=x₁/sin(θ), respectively. A product α*d of optical loss α (in 1/cm) and article thickness d (in cm) is defined as normalized optical loss NOL. At a propagation angle θ_{mid} the normalized optical loss NOL(θ_{mid}) is smaller than 0.02, where sin(θ_{mid})=0.83. A dependence of the normalized optical loss NOL from the propagation angle θ is such that

$$- 0.03 \leq \frac{NOL ( {θ}_{2} ) - NOL ( {θ}_{1} )}{sin ( {θ}_{2} ) - sin ( {θ}_{1} )} . \leq 0.03 \cdot {θ}_{2}$$

is a propagation angle with sin(θ₂)=0.98 and θ₁ is a propagation angle with sin(θ₁)=0.75.

In some exemplary embodiments provided according to the present invention, a glass article has a thickness t and includes a glass having a fracture toughness K_{Ic} of more than 0.4 MPa·√m. The glass article is characterized by a course of light intensity upon propagation of light having a wavelength of 450 nm inside the glass article based on total internal reflection at a propagation angle θ formed between a normal to a surface of the glass article and a propagation direction of the light approaching the surface. The course of light intensity is determined by moving an optical fiber across the surface of the glass article in a direction of the propagating light beam and along the way detecting the light which was scattered and thereby left the glass article at different lateral path positions xᵢ of the optical fiber over a lateral path distance of the optical fiber of at least 2 cm. The course of light intensity is characterized by a plurality of alternating local maxima (max) and local minima (min) in a logarithmic light intensity curve showing the natural logarithm of the light intensity detected by the optical fiber on the y-axis and the corresponding lateral path position xᵢ of the optical fiber on the x-axis. The logarithmic light intensity curve includes a plurality of periodically occurring principal local maxima characterized by a distance between the lateral path positions of two neighboring principal local maxima being equal to 2*t*tan(θ)±100 μm. The logarithmic light intensity curve includes a plurality of sequences maxₙ−minₙ−maxₙ₊₁ of a local minimum minₙ located between two local maxima maxₙ and maxₙ₊₁ at corresponding lateral path positions x(maxₙ)<x(minₙ)<x(maxₙ₊₁). I(maxₙ), I(minₙ) and I(maxₙ₊₁) are the light intensities at lateral path positions x(maxₙ), x(minₙ) and x(maxₙ₊₁), respectively. A height Aₙ of a first local maximum maxₙ is defined as ln(I(maxₙ))−ln(I(minₙ)). A height Aₙ₊₁ of a second local maximum maxₙ₊₁ is defined as ln(I(maxₙ₊₁))−ln(I(minₙ)), Aₙ>Aₙ₊₁, and maxₙ is a principal local maximum. maxₙ₊₁ is a principal local maximum provided that a difference x(maxₙ₊₁)−x(maxₙ)=2*t*tan(θ)±100 μm. maxₙ₊₁ is a secondary local maximum provided that the difference x(maxₙ₊₁)−x(maxₙ)≠2*t*tan(θ)±100 μm. The glass article is characterized by absence of a secondary local maximum having a height Aₙ₊₁ which is more than z % of the height Aₙ of the corresponding principal local maximum for any sequence maxₙ−minₙ−maxₙ₊₁ with x(maxₙ)>0.4 cm and with x(maxₙ₊₁)<2.0 cm in a logarithmic light intensity curve for at least one propagation angle θ in a range of from 65° to 80°, where z %=50%.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows a setup that may be used for determining an optical loss according to the present invention;

FIG. 2 shows experimental results determined by the method shown in FIG. 1 for different propagation angles ranging from 45° to 85°;

FIGS. 3A to 3C show results for different samples of a glass that differ from each other by the surface roughness;

FIGS. 3D and 3E show the results for different samples of a glass that differ from each other by the amount of sub-surface damages (SSDs);

FIGS. 4 to 7 show experimental results determined by the method shown in FIG. 1 for different propagation angles, with FIG. 4 showing the result of example F, FIG. 5 showing the results of example G, FIG. 6 showing the results of example H, and FIG. 7 showing the results of example I;

FIG. 8 shows that the observed periodicity can be explained as a sum (superposition) of two sinus functions;

FIG. 9 shows a superposition of two sinus functions including a decay;

FIG. 10 shows an enlarged part of the curve of FIG. 9 for illustration of principal local maxima and secondary local maxima; and

FIG. 11 shows a setup of FIG. 1.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

Exemplary embodiments disclosed herein provide a glass article including a glass having a fracture toughness K_{Ic} of more than 0.4 MPa·√m, the article having an article thickness d. The article is characterized by an optical loss α upon propagation of light having a wavelength of 450 nm inside the article based on total internal reflection at a propagation angle θ formed between the normal to a surface of the glass article and the propagation direction of the light approaching the surface, the optical loss α is determined by moving an optical fiber across the surface of the article in the direction of the propagating light beam and along the way detecting the light which was scattered and thereby left the article at different lateral path positions xᵢ of the optical fiber over a lateral path distance of the optical fiber of at least 2 cm, the optical loss α is determined by the formula

$$α = \frac{ln ( {I}_{2} ) - ln ( {I}_{1} )}{{OP}_{2} - {OP}_{1}} .$$

where I₂ and I₁ are light intensities at lateral path positions x₂ and x₁, respectively, of the optical fiber determined based on ln(I₂)=f(x₂) and ln(I₁)=f(x₁), respectively, with f(x) being the least squares linear regression describing the dependence of the natural logarithm of the detected light intensity from the lateral path position x of the optical fiber, OP₂ and OP₁ are the optical path positions corresponding to the lateral path positions x₂ and x₁, respectively, with OP₂ and OP₁ determined as OP₂=x₂/sin(θ) and OP₁=x₁/sin(θ), respectively. A product α*d of optical loss α (in 1/cm) and article thickness d (in cm) is defined as normalized optical loss NOL, at a propagation angle θ_{mid} the normalized optical loss NOL(θ_{mid}) is smaller than 0.02, where sin(θ_{mid})=0.83. The dependence of the normalized optical loss NOL from the propagation angle θ is such that

$$- 0.03 \leq \frac{NOL ( {θ}_{2} ) - NOL ( {θ}_{1} )}{sin ( {θ}_{2} ) - sin ( {θ}_{1} )} . \leq 0.03 ,$$

where θ₂ is a propagation angle with sin(θ₂)=0.98 and θ₁ is a propagation angle with sin(θ₁)=0.75.

In some embodiments, the present invention also relates to a glass article having a thickness t, the article including a glass having a fracture toughness K_{Ic} of more than 0.4 MPa·√m. The article is characterized by a course of light intensity upon propagation of light having a wavelength of 450 nm inside the article based on total internal reflection at a propagation angle θ formed between the normal to a surface of the glass article and the propagation direction of the light approaching the surface, the course of light intensity being determined by moving an optical fiber across the surface of the article in the direction of the propagating light beam and along the way detecting the light which was scattered and thereby left the article at different lateral path positions xᵢ of the optical fiber over a lateral path distance of the optical fiber of at least 2 cm. The course of light intensity is characterized by a plurality of alternating local maxima (max) and local minima (min) in a logarithmic light intensity curve showing the natural logarithm of the light intensity detected by the optical fiber on the y-axis and the corresponding lateral path position xᵢ of the optical fiber on the x-axis. The logarithmic light intensity curve includes a plurality of periodically occurring principal local maxima characterized by the distance between the lateral path positions of two neighboring principal local maxima being equal to 2*t*tan(θ)±100 μm. The logarithmic light intensity curve includes a plurality of sequences maxₙ−minₙ−maxₙ₊₁ of a local minimum minᵢ, located between two local maxima maxₙ and maxₙ₊₁ at corresponding lateral path positions x(maxₙ)<x(minₙ)<x(maxₙ₊₁), where I(maxₙ), I(minₙ) and I(maxₙ₊₁) are the light intensities at lateral path positions x(maxₙ), x(minₙ) and x(maxₙ₊₁), respectively, the height Aₙ of the first local maximum maxₙ is defined as ln(I(maxₙ))−ln(I(minₙ)), the height Aₙ₊₁ of the second local maximum maxₙ₊₁ is defined as ln(I(maxₙ₊₁))−ln(I(minₙ)), Aₙ>Aₙ₊₁, maxₙ is a principal local maximum, maxₙ₊₁ is a principal local maximum provided that the difference x(maxₙ₊₁)−x(maxₙ)=2*t*tan(θ)±100 μm, and maxₙ₊₁ is a secondary local maximum provided that the difference x(maxₙ₊₁)−x(maxₙ)≠2*t*tan(θ)±100 μm. The article is characterized by absence of a secondary local maximum having a height Aₙ₊₁ which is more than z % of the height Aₙ of the corresponding principal local maximum for any sequence maxₙ−minₙ−maxₙ₊₁ with x(maxₙ)>0.4 cm and with x(maxₙ₊₁)<2.0 cm in a logarithmic light intensity curve for at least one propagation angle θ in a range of from 65° to 80°, where z %=50%.

The global maximum of the logarithmic light intensity curve may in particular correspond to one of the principal local maxima of the logarithmic light intensity curve.

In some embodiments, the distance between the lateral path positions of two neighboring principal local maxima may be equal to 2*t*tan(θ)±80 μm, or equal to 2*t*tan(θ) 60 μm.

In some embodiments, the glass article provided according to the present invention is characterized by the normalized optical loss NOL(θ_{mid}) being smaller than 0.02 at a propagation angle θ_{mid}, where sin(θ_{mid})=0.83, the dependence of the normalized optical loss NOL from the propagation angle θ being such that

$$- 0.03 \leq \frac{NOL ( {θ}_{2} ) - NOL ( {θ}_{1} )}{sin ( {θ}_{2} ) - sin ( {θ}_{1} )} . \leq 0.03 ,$$

where θ₂ is a propagation angle with sin(θ₂)=0.98 and θ₁ is a propagation angle with sin(θ₁)=0.75, and absence of a secondary local maximum having a height Aₙ₊₁ which is more than 50% of the height Aₙ of the corresponding principal local maximum for any sequence maxₙ−minₙ−maxₙ₊₁ with x(maxₙ)>0.4 cm and with x(maxₙ₊₁)<2.0 cm in the logarithmic light intensity curve obtained for at least one angle θ in a range of from 65° to 80°.

In some embodiments, the glass article may be characterized by absence of a secondary local maximum having a height Aₙ₊₁ which is more than 50%, more than 45%, more than 40%, more than 35%, more than 30%, more than 25%, more than 20%, more than 15%, more than 10%, more than 5%, more than 2%, or more than 1% of the height Aₙ of the corresponding principal local maximum for any sequence maxₙ−minₙ−maxₙ₊₁ with x(maxₙ)>0.4 cm and with x(maxₙ₊₁)<2.0 cm in the logarithmic light intensity curve for at least one propagation angle θ in a range of from 65° to 80°. In other words, z % may, for example, be 50%, 45%, 40%, 35%, 30%, 25%, 20%, 15%, 10%, 5%, 2%, or 1%.

In some embodiments, there is x(maxₙ₊₁)<2.5 cm, x(maxₙ₊₁)<3.0 cm, x(maxₙ₊₁)<3.5 cm, x(maxₙ₊₁)<4.0 cm, x(maxₙ₊₁)<4.5 cm, x(maxₙ₊₁)<5.0 cm, x(maxₙ₊₁)<5.5 cm, x(maxₙ₊₁)<6.0 cm, x(maxₙ₊₁)<6.5 cm, x(maxₙ₊₁)<7.0 cm, x(maxₙ₊₁)<7.5 cm, x(maxₙ₊₁)<8.0 cm, x(maxₙ₊₁)<8.5 cm, or x(maxₙ₊₁)<9.0 cm.

The glass article provided according to the present invention may be characterized by several advantages. For example, the overall optical loss of light propagating inside the article based on total internal reflection is low. Thus, there is no need for a strong signal to be fed into the article. Moderate intensities are sufficient for creating an advantageous brightness of the image because the optical loss is low. Furthermore, the dependence of optical loss from the propagation angle inside the article is low. This is advantageous because it results in a very homogeneous brightness distribution throughout the entire article. Notably, low propagation angles are generally associated with the image created in the center of an AR device. In contrast, high propagation angles are generally associated with the image created towards the edges of an AR device. If the optical losses differ strongly dependent on the propagation angle of the light inside the glass, this results in a heterogeneous brightness distribution. For example, the image may be very bright in the center and very dark towards the edges or vice versa. Therefore, the article provided according to provided according to the present invention having a low dependence of optical loss from the propagation angle is very advantageous.

Surprisingly it was found that the optical loss can be reduced by increasing the fracture toughness. Fracture toughness K_{IC} is to be understood as the fracture toughness under tensile load (Mode I). This fracture toughness is given in MPa·√m and may be measured with the “Precracked-Beam-Method” described in ASTM-Norm C1421-15 (p. 9 ff.). The fracture toughness K_{IC} may be determined by one or more reference articles. In some embodiments, the articles used for determination of the fracture toughness K_{IC} are not toughened, in particular not chemically toughened. According to the present invention, K₁ is larger than 0.40 MPa·√m. In some embodiments, K_{Ic} is at least 0.45 MPa·√m, for example at least 0.50 MPa·√m, at least 0.55 MPa·√m, at least 0.60 MPa·√m, or at least 0.65 MPa·√m. In some embodiments, K_{Ic} is at most 1.00 MPa·√m, for example at most 0.95 MPa·√m, at most 0.90 MPa·√m, at most 0.85 MPa·√m, at most 0.80 MPa·√m, or at most 0.75 MPa·√m. In some embodiments, K_{IC} is in a range of >0.4 MPa·√m to 1.00 MPa·√m, for example from 0.45 MPa·√m to 0.95 MPa·√m, from 0.50 MPa·√m to 0.90 MPa·√m, from 0.55 MPa·√m to 0.85 MPa·√m, from 0.60 to 0.80 MPa·√m, or from 0.65 to 0.75 MPa·√m.

The article provided according to the present invention has an article thickness d. In some embodiments, the thickness d of the article is in a range of from 0.10 mm to 2.0 mm, such as from 0.15 mm to 1.5 mm, from 0.20 mm to 1.2 mm, from 0.25 mm to 1.0 mm, or from 0.30 mm to 0.70 mm, for example from 0.40 mm to 0.60 mm. The thickness d of the article may, for example, be at least 0.10 mm, at least 0.15 mm, at least 0.20 mm, at least 0.25 mm, at least 0.30 mm, or at least 0.40 mm. The thickness d of the article may, for example, be at most 2.0 mm, at most 1.5 mm, at most 1.2 mm, at most 1.0 mm, at most 0.7 mm, or at most 0.60 mm.

In some embodiments, the article is a glass wafer, in particular a planar glass wafer such as a planar waveguide. In some embodiments, the article has two main surfaces. In some embodiments, the main surfaces have about the same surface area. In some embodiments, each main surface has a surface area in the range of from 1,000 to 1,000,000 mm², for example from 3,000 to 750,000 mm², from 5,000 to 500,000 mm², for example from 10,000 to 400,000 mm², from 20,000 to 300,000 mm², from 30,000 to 200,000 mm², from 40,000 to 150,000 mm², from 50,000 to 125,000 mm², or from 60,000 to 100,000 mm².

The article provided according to the present invention is characterized by an optical loss α upon propagation of light having a wavelength of 450 nm inside the article based on total internal reflection at a propagation angle θ formed between the normal to a surface of the glass article and the propagation direction of the light approaching said surface. In some embodiments, the optical loss α is determined for the medium surrounding the article having a refractive index of about 1.00, in particular for such medium being a gaseous medium, such as air. In some embodiments, the optical loss α is determined at room temperature, in particular at a temperature of about 20° C.

The article provided according to the present invention may be characterized by absence of a secondary local maximum having a height Aₙ₊₁ which is more than 50% of the height Aₙ of the corresponding principal local maximum for any sequence maxₙ−minₙ−maxₙ₊₁ with x(maxₙ)>0.4 cm and with x(maxₙ₊₁)<2.0 cm in a logarithmic light intensity curve for at least one propagation angle θ in a range of from 65° to 80° upon propagation of light having a wavelength of 450 nm inside the article based on total internal reflection at the propagation angle θ formed between the normal to a surface of the glass article and the propagation direction of the light approaching said surface. In some embodiments, the course of light intensity is determined for the medium surrounding the article having a refractive index of about 1.00, in particular for such medium being a gaseous medium, such as air. In some embodiments, the course of light intensity is determined at room temperature, in particular at a temperature of about 20° C.

Notably, the optical loss α and the presence/absence of secondary local maxima can be determined based on the same logarithmic light intensity curves. For example, if a light intensity curve has been recorded for a particular glass article, the data can be used to determine both the optical loss α and the presence/absence of secondary local maxima.

The optical loss α is determined for a propagation distance (also called optical path distance) inside the article. The propagation distance describes the distance of propagation of light inside the article used for determination of the optical loss α. The optical loss α is dependent on the propagation distance. For example, the optical loss α is greater for a greater propagation distance as compared to a lower propagation distance. The reason is that there are scattering or absorption events during propagation through the inside of the article. Thus, the greater the propagation distance is, the more absorption and/or scattering events take place. The term “optical loss α” refers to the total optical loss, i.e. including optical loss by scattering and optical loss by absorbance.

A lateral path distance of at least 2 cm of the optical fiber is important in order to ensure that there is sufficient and well enough light intensity data for properly determining f(x) based on least squares linear regression. A lateral path distance of the optical fiber of at least 3 cm, at least 4 cm or at least 5 cm may be even more advantageous. In some embodiments, the lateral path distance of the optical fiber does not exceed 9 cm.

As the optical loss is dependent on the optical path distance that the light propagates inside the glass article (also called propagation distance) and not on the lateral path distance of the optical fiber, it is important that the optical positions corresponding to the lateral path positions of the optical fiber are determined as indicated above. Determining the optical position OPᵢ corresponding to the lateral path position xᵢ is done as OPᵢ=xᵢ/sin(θ). For example, at a propagation angle θ of 45° (sin(θ)≈0.71), a lateral path position xᵢ=5 cm corresponds to an optical position OPᵢ of about 5/0.71 cm, i.e. about 7 cm. Thus, at a propagation angle of 45° the light has propagated a distance of about 7 cm inside the glass article at a position corresponding to a lateral path position of the optical fiber of 5 cm.

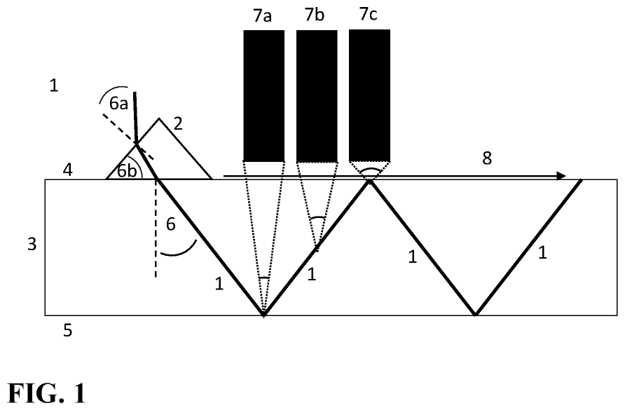

In some embodiments, optical loss α and/or the presence/absence of secondary local maxima is determined using the prism coupler tool “Metricon” (see also FIG. 1). Laser light is coupled into a glass article, in particular a planar waveguide by a prism and propagates in the glass article. An optical fiber, which is moved in close distance (generally less than 1 mm) across the surface in the direction of the propagating beam, detects the light which is scattered and thereby leaves the article. Scattering and absorbance might lead to a significant decrease of the detected light intensity along the propagation, following an exponential decay with the fiber's lateral path. The total optical losses can be evaluated by mathematically fitting the curve and calculating the decay coefficient.

Total optical losses are the sum of several contributions, such as volume scattering, volume related absorption, and surface scattering due to roughness. Volume scattering and absorption originate from the material itself, occurring (mostly homogeneously) in the whole volume of the wafer. In case of glass wafer, volume scattering can furthermore originate from imperfections in a zone close to the surface (approximately a couple of micrometer), having its origin in the fabrication process of the substrate (e.g. cutting, grinding, polishing, etc.). These imperfections are called sub-surface damages (SSD). The extent of SSDs may be determined visually upon chemical etching.

Measuring the losses at different propagation angles and plotting the optical losses at each propagation angle with respect to the optical path, one can determine the influence of different contributions:
If there was a negative slope of the plot “optical loss vs. propagation angle”, there is surface roughness
If there was a positive slope of the plot “optical loss vs. propagation angle”, there are SSD
If there was no change in optical loss with the propagation angle, there is
Either no surface scattering and no SSD, resulting in an optical loss that is known from bulk measurements, or
Coincidentally an equal contribution of both, roughness and SSD that level out each other, however leading to loss level as the one that is expected from pure bulk material.

In order to perform a reliable measurement of the total optical loss of such a planar waveguide (e.g. a glass wafer) as mentioned above, one has to take care on the alignment of the laser beam with respect to the coupling spot. There is an alignment procedure that has to be performed prior to a measurement at a given propagation angle. The details are disclosed below.

At first, the glass article should be cleaned, leading to surfaces of the article that are free of dust and other residuals. The cleaning procedure should not harm and change the surface, but just wash away dust and other residuals.

The clean glass article is mounted into the Metricon tool as described in the tool's manual. The article is pressed against the prism's base by the so called “coupling head”. The typical coupling pressure is in the order of 30 to 45 psi. If the wafer is correctly mounted, one can visually see the coupling spot, which is a circular shaped area at the prism's base occurring from the locally close contact of prism to the glass article, the spot having a diameter of approximately 1 to 2 mm.

The direction of the laser beam is adjusted by tilted mirrors in x and y direction to meet the coupling spot and to inject the beam into the glass article. To improve the usable lateral length for evaluation, one can cancel back reflection at the article's edge by darkening this edge with a black pen, e.g. Edding. Prior to measuring, the cover is applied to the cabin to avoid disturbing light from the surrounding area.

In order to firstly align the laser one can use any angle of incidence (AOI)β(reference sign 6a in FIG. 1) of the beam with respect to the side area of the prism that leads to a propagation of the beam inside the glass article, e.g. 0°. By varying the tilted mirrors of the system in x- and y-direction, one can guide the laser beam to the coupling spot. Coupling is confirmed by an analog display that shows a signal different from zero. The optimal coupling position is found by carefully turning the x- and y-tilted mirrors sequentially to maximize the reading. In case the signal is too high, one has to reduce the gain factor by turning the corresponding knob.

Once that the maximum signal is found, laser path is masked by the intrinsic shutter and the offset is set to zero. After setting the offset to zero, the shutter is opened again, and the signal amplification is adjusted such, that the analog reading shows approximately 80%. The system is now set up to perform the measurement at the given AOI of 0°.

When changing the AOI, the laser beam has to be aligned onto the coupling spot again by carefully adjusting the x- and y-mirror positions as described above, increasing the analog reading to a maximum. Once the maximum reading is found, one has to check for the offset again and one can perform the measurement.

As it turns out, this alignment of the laser onto the coupling spot by using the x and y tilted mirrors to achieve the optimal reading at different AOI is necessary in order to receive reliable results that can be compared with each other.

By definition, the AOI of β=0° is given when the laser beam meets the side surface of the prism perpendicularly. The propagation angle θ (reference sign 6 in FIG. 1) can be calculated knowing the AOI β, the refractive index of the substrate n, the refractive index of the prism n₁ and the angle ω (reference sign in 6b in FIG. 1) of the prism between the prism's base and the side where the beam enters the prism. The refractive index of air no is considered to be 1. The propagation angle θ for a given AOI β is calculated according to

$$θ = arcsin ( \frac{{n}_{1}}{n} sin ( arcsin ( \frac{{n}_{0}}{{n}_{1}} sin ( β ) ) + ω ) )$$

To choose a certain propagation angle one can transpose above equation to β:

$$β = arcsin ( \frac{{n}_{1}}{{n}_{0}} sin ( arcsin ( \frac{n}{{n}_{1}} sin ( θ ) ) - ω ) )$$

The possible range of propagation angles θ of the beam inside the substrate depends on the substrate's refractive index. Therefore, the term sin (θ) may be preferred as compared to the absolute angle. In case of the maximum propagation angle, the condition sin(θₘₐₓ)=1 is fulfilled. The minimum propagation angle is defined by the equation sin(θₘᵢₙ)=1/n, where n is the refractive index of the substrate.

At a given substrate thickness, the propagation angle determines the number of surface interactions: the greater the angle gets, the less bounces of the beam between the surfaces take place. The smaller the angle gets, the more bounces happen. Additionally, the article thickness also contributes to the number of surface interactions. At a given propagation angle, a thinner glass article will show more bounces than a thicker one, suggesting that the surface contributions in case of a thick samples are less. To give a comprehensive result, the product of optical loss α (in 1/cm) and article thickness d (in cm) is defined as normalized optical loss NOL. The normalized optical loss NOL is a dimensionless number that can be used to compare different glass article of different thicknesses.

As described above, for a given propagation angle θ, the optical loss α is dependent on the thickness d of the article because the optical loss is dependent on the number of surface contacts along the propagation distance. Optical loss is not only caused by absorption and scattering in the bulk material but also at the surface, for example surface scattering. If the thickness of the article is large, the number of surface contacts is comparably low for a given propagation angle θ and a given propagation distance. On the other hand, a low thickness is associated with a greater number of surface contacts for a given propagation angle θ and a given propagation distance. Consequently, the product α*d of optical loss α (in 1/cm) and article thickness d (in cm) is defined as normalized optical loss NOL.

As described above, the present invention may be characterized by a twofold advantage, namely a low optical loss and a low dependence of the optical loss on the propagation angle θ. Therefore, a bright image with a homogeneous brightness distribution can be obtained.

In the present disclosure, the amount of optical loss is described as normalized optical loss NOL as described above. However, the normalized optical loss NOL (although being normalized to the thickness d of the article) turned out to be dependent on the propagation angle θ, for example dependent on the surface roughness and subsurface damages (SSDs). Thus, NOL may be different for a high propagation angle θ as compared to a low propagation angle θ so that the normalized optical loss is difficult to be described independent of the propagation angle θ. Therefore, in order to find a measure for describing the extent of normalized optical loss NOL in a way that allows a comfortable comparison between different glass articles, a representative propagation angle θ has to be defined. In this respect, the present disclosure defines the propagation angle θ_{mid}, with sin(θ_{mid})=0.83. The propagation angle θ_{mid} may be described as the “middle propagation angle” or “medium propagation angle” between the extremes of θₘₐₓ, with sin(θₘₐₓ)=1, and θₘᵢₙ, with sin(θₘᵢₙ)=1/n. At θₘₐₓ, the light propagates parallel to the main surfaces of the glass article. The propagation angle θₘᵢₙ, is the lowest angle at which total internal reflection occurs. Thus, for θ<θₘᵢₙ there is no total internal reflection and thus no propagation of light through the inside of the article based total internal reflection. In this respect, θ_{mid} as defined above represents a reasonable propagation angle between the extreme values of θₘₐₓ and θₘᵢₙ. Consequently, the extent of normalized optical loss NOL is given herein for θ=θ_{mid}. Notably, it is not necessary that NOL is experimentally measured at θ=θ_{mid}. Instead, NOL(θ_{mid}) may also be estimated based on a linear fit of the dependence of NOL from the sinus of the propagation angle, wherein the linear fit may be determined based on experimentally determined values of NOL at θ₂ with sin(θ₂)=0.98 and at θ₁ with sin(θ₁)=0.75. Alternatively, the linear fit may be determined based on NOL values measured for at least five different propagation angles in the range of from ≥θₘᵢₙ to ≤θₘₐₓ, where the range includes θ_{mid}, where the difference of the sinus of the largest propagation angle tested and the sinus of the smallest propagation angle tested is at least 0.25, and where the difference of the sinus of each propagation angle tested to the sinus of each other propagation angle tested is at least 0.01.

According to the present invention, NOL(θ_{mid}) is smaller than 0.02, such as smaller than 0.018, smaller than 0.016, smaller than 0.014, smaller than 0.012, smaller than 0.01, smaller than 0.009, smaller than 0.008, smaller than 0.007, smaller than 0.006, smaller than 0.005, smaller than 0.004, or smaller than 0.003 for light having a wavelength of 450 nm. NOL(θ_{mid}) may be at least 0.00001 or at least 0.00002 for light having a wavelength of 450 nm.

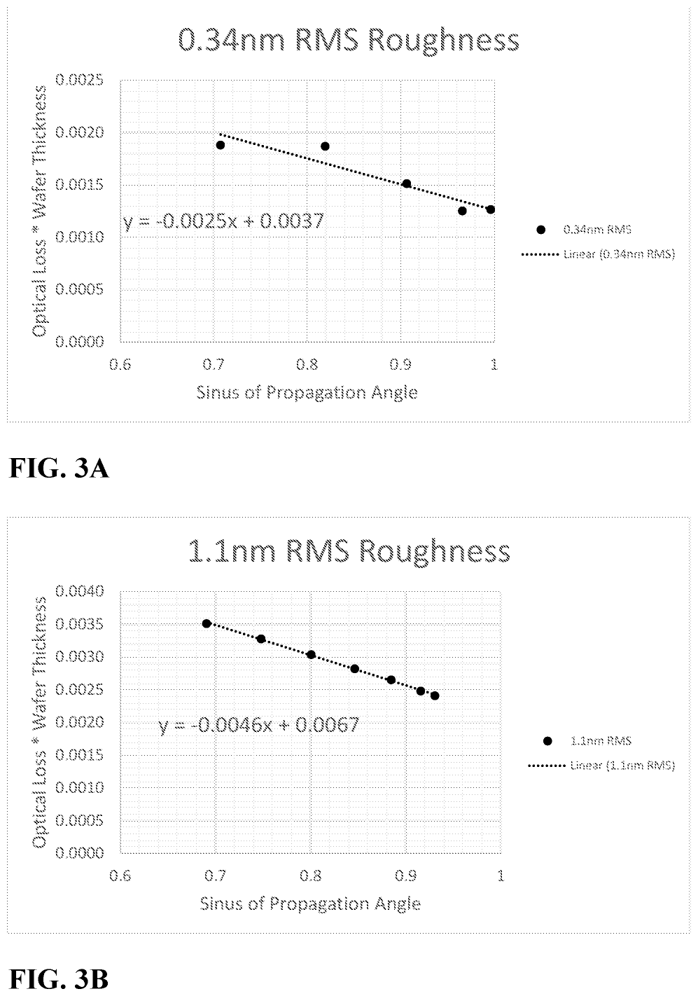

The present invention is not only characterized by a particular low normalized optical loss NOL. The present invention further provides a very low dependence of NOL from the propagation angle θ. As described above, complete independence of NOL from the propagation angle θ is very difficult to achieve. For example, surface roughness has stronger influence on optical loss at low propagation angles as compared to high propagation angles (negative slope in FIGS. 3A to 3C). On the other hand, sub surface damages (SSDs) have a stronger influence on optical loss at high propagation angles as compared to low propagation angles (positive slope in FIGS. 3D and 3E). Thus, the slope of the dependence of NOL from propagation angle θ has to be controlled in both directions in order to avoid or reduce brightness heterogeneity.

In order to quantify the dependence of NOL from propagation angle θ the difference between two NOL values at different propagation angles can be compared. This difference can be normalized by dividing through the difference of the respective propagation angles or the difference of the sinus values of the propagation angles. In the present disclosure, the term

$$\frac{NOL ( {θ}_{2} ) - NOL ( {θ}_{1} )}{sin ( {θ}_{2} ) - sin ( {θ}_{1} )}$$

is used as a measure for the dependence of NOL from the propagation angle. In order to get a robust measure, it is reasonable to choose θ₁ and θ₂ such that they are not too close together. On the other hand, θ₁ and θ₂ should not be too close to the extreme values θₘᵢₙ and θₘₐₓ either. As described above, sin(θₘₐₓ)=1 and sin(θₘᵢₙ)=1/n. Therefore, it was chosen that θ₂ is a propagation angle with sin(θ₂)=0.98 and θ₁ is a propagation angle with sin(θ₁)=0.75. Thus, θ₁ and θ₂ are reasonably apart from each other and still θ₁ is not too close to θₘᵢₙ and θ₂ is not too close to θₘₐₓ.

According to the present invention,

$$\frac{NOL ( {θ}_{2} ) - NOL ( {θ}_{1} )}{sin ( {θ}_{2} ) - sin ( {θ}_{1} )}$$

is at most 0.03, such as at most 0.025, at most 0.02, at most 0.015, at most 0.01, at most 0.009, at most 0.008, at most 0.007, at most 0.006, or at most 0.005 for light having a wavelength of 450 nm. In some embodiments,

$$\frac{NOL ( {θ}_{2} ) - NOL ( {θ}_{1} )}{sin ( {θ}_{2} ) - sin ( {θ}_{1} )}$$

may be at least 0.00001 or at least 0.00002 for light having a wavelength of 450 nm.

According to the present invention,

$$\frac{NOL ( {θ}_{2} ) - NOL ( {θ}_{1} )}{sin ( {θ}_{2} ) - sin ( {θ}_{1} )}$$

is at least −0.03, such as at least −0.025, at least −0.02, at least −0.015, at least −0.01, at least −0.009, at least −0.008, at least −0.007, at least −0.006, or at least −0.005 for light having a wavelength of 450 nm. In some embodiments,

$$\frac{NOL ( {θ}_{2} ) - NOL ( {θ}_{1} )}{sin ( {θ}_{2} ) - sin ( {θ}_{1} )}$$

may be at most −0.001 or at most −0.002 for light having a wavelength of 450 nm.

According to the present invention, there is

$$- 0.03 \leq \frac{NOL ( {θ}_{2} ) - NOL ( {θ}_{1} )}{sin ( {θ}_{2} ) - sin ( {θ}_{1} )} \leq 0.03 ,$$

for example

$$- 0.025 \leq \frac{NOL ( {θ}_{2} ) - NOL ( {θ}_{1} )}{sin ( {θ}_{2} ) - sin ( {θ}_{1} )} \leq 0.025 , \\ - 0.02 \leq \frac{NOL ( {θ}_{2} ) - NOL ( {θ}_{1} )}{sin ( {θ}_{2} ) - sin ( {θ}_{1} )} \leq 0.02 , \\ - 0.015 \leq \frac{NOL ( {θ}_{2} ) - NOL ( {θ}_{1} )}{sin ( {θ}_{2} ) - sin ( {θ}_{1} )} \leq 0.015 , \\ - 0.01 \leq \frac{NOL ( {θ}_{2} ) - NOL ( {θ}_{1} )}{sin ( {θ}_{2} ) - sin ( {θ}_{1} )} \leq 0.01 , \\ - 0.009 \leq \frac{NOL ( {θ}_{2} ) - NOL ( {θ}_{1} )}{sin ( {θ}_{2} ) - sin ( {θ}_{1} )} \leq 0.009 , \\ - 0.008 \leq \frac{NOL ( {θ}_{2} ) - NOL ( {θ}_{1} )}{sin ( {θ}_{2} ) - sin ( {θ}_{1} )} \leq 0.008 , \\ - 0.007 \leq \frac{NOL ( {θ}_{2} ) - NOL ( {θ}_{1} )}{sin ( {θ}_{2} ) - sin ( {θ}_{1} )} \leq 0.007 , \\ - 0.006 \leq \frac{NOL ( {θ}_{2} ) - NOL ( {θ}_{1} )}{sin ( {θ}_{2} ) - sin ( {θ}_{1} )} \leq 0.006 , \\ or \\ - 0.005 \leq \frac{NOL ( {θ}_{2} ) - NOL ( {θ}_{1} )}{sin ( {θ}_{2} ) - sin ( {θ}_{1} )} \leq 0.005$$

for light having a wavelength of 450 nm.

Notably, it is not necessary that NOL is experimentally measured at θ=θ₁ or at θ=θ₂. Instead, NOL(θ₁) and NOL(θ₂) may also be estimated based on a linear fit of the dependence of NOL from the sinus of the propagation angle. The linear fit may be determined based on NOL values measured for at least five different propagation angles in the range of from ≥θₘᵢₙ to ≤θₘₐₓ, where the range includes θ_{mid}, where the difference of the sinus of the largest propagation angle tested and the smallest propagation angle tested is at least 0.25, and where the difference of the sinus of each propagation angle tested to the sinus of each other propagation angle tested is at least 0.01.

The present invention is herein described based on propagation of light having a

$$\frac{NOL ( {θ}_{2} ) - NOL ( {θ}_{1} )}{sin ( {θ}_{2} ) - sin ( {θ}_{1} )}$$

wavelength of 450 nm inside the article, in particular concerning NOL(θ_{mid}) and as described above. In aspects of the present invention, the respective properties are also achieved with light of other wavelengths. In particular, it was found that the optical loss is generally lower for higher wavelengths, probably at least partially due to decreased influence of volume scattering effects.

Thus, in some embodiments NOL(θ_{mid}) may be smaller than 0.02, such as smaller than 0.018, smaller than 0.016, smaller than 0.014, smaller than 0.012, smaller than 0.01, smaller than 0.009, smaller than 0.008, smaller than 0.007, smaller than 0.006, smaller than 0.005, smaller than 0.004, or smaller than 0.003 for light having a wavelength of 450 nm and for light having a wavelength of more than 450 nm, for example for light having a wavelength in a range of from 450 nm to 760 nm, such as from 450 nm to 500 nm, from 500 nm to 610 nm and/or from 610 nm to 760 nm. NOL(θ_{mid}) may be at least 0.00001 or at least 0.00002 for light having a wavelength of 450 nm and for light having a wavelength of more than 450 nm, for example for light having a wavelength in a range of from 450 nm to 760 nm, such as from 450 nm to 500 nm, from 500 nm to 610 nm and/or from 610 nm to 760 nm.

In some embodiments provided according to the present invention,

$$\frac{NOL ( {θ}_{2} ) - NOL ( {θ}_{1} )}{sin ( {θ}_{2} ) - sin ( {θ}_{1} )}$$

is at most 0.03, such as at most 0.025, at most 0.02, at most 0.015, at most 0.01, at most 0.009, at most 0.008, at most 0.007, at most 0.006, or at most 0.005 for light having a wavelength of 450 nm and for light having a wavelength of more than 450 nm, for example for light having a wavelength in a range of from 450 nm to 760 nm, such as from 450 nm to 500 nm, from 500 nm to 610 nm and/or from 610 nm to 760 nm. In some embodiments,

$$\frac{NOL ( {θ}_{2} ) - NOL ( {θ}_{1} )}{sin ( {θ}_{2} ) - sin ( {θ}_{1} )}$$

may be at least 0.00001 or at least 0.00002 for light having a wavelength of 450 nm and for light having a wavelength of more than 450 nm, for example for light having a wavelength in a range of from 450 nm to 760 nm, such as from 450 nm to 500 nm, from 500 nm to 610 nm and/or from 610 nm to 760 nm.

In some embodiments provided according to the present invention,

$$\frac{NOL ( {θ}_{2} ) - NOL ( {θ}_{1} )}{sin ( {θ}_{2} ) - sin ( {θ}_{1} )}$$

is at least −0.03, such as at least −0.025, at least −0.02, at least −0.015, at least −0.01, at least −0.009, at least −0.008, at least −0.007, at least −0.006, or at least −0.005 for light having a wavelength of 450 nm and for light having a wavelength of more than 450 nm, for example for light having a wavelength in a range of from 450 nm to 760 nm, such as from 450 nm to 500 nm, from 500 nm to 610 nm and/or from 610 nm to 760 nm. In some embodiments,

$$\frac{NOL ( {θ}_{2} ) - NOL ( {θ}_{1} )}{sin ( {θ}_{2} ) - sin ( {θ}_{1} )}$$

may be at most −0.001 or at most −0.002 for light having a wavelength of 450 nm and for light having a wavelength of more than 450 nm, for example for light having a wavelength in a range of from 450 nm to 760 nm, such as from 450 nm to 500 nm, from 500 nm to 610 nm and/or from 610 nm to 760 nm.

In some embodiments provided according to the present invention, there is

$$- 0.03 \leq \frac{NOL ( {θ}_{2} ) - NOL ( {θ}_{1} )}{sin ( {θ}_{2} ) - sin ( {θ}_{1} )} \leq 0.03 , \\ such as \\ - 0.025 \leq \frac{NOL ( {θ}_{2} ) - NOL ( {θ}_{1} )}{sin ( {θ}_{2} ) - sin ( {θ}_{1} )} \leq 0.025 , \\ - 0.02 \leq \frac{NOL ( {θ}_{2} ) - NOL ( {θ}_{1} )}{sin ( {θ}_{2} ) - sin ( {θ}_{1} )} \leq 0.02 , \\ - 0.015 \leq \frac{NOL ( {θ}_{2} ) - NOL ( {θ}_{1} )}{sin ( {θ}_{2} ) - sin ( {θ}_{1} )} \leq 0.015 , \\ - 0.01 \leq \frac{NOL ( {θ}_{2} ) - NOL ( {θ}_{1} )}{sin ( {θ}_{2} ) - sin ( {θ}_{1} )} \leq 0.01 , \\ - 0.009 \leq \frac{NOL ( {θ}_{2} ) - NOL ( {θ}_{1} )}{sin ( {θ}_{2} ) - sin ( {θ}_{1} )} \leq 0.009 , \\ - 0.008 \leq \frac{NOL ( {θ}_{2} ) - NOL ( {θ}_{1} )}{sin ( {θ}_{2} ) - sin ( {θ}_{1} )} \leq 0.008 , \\ - 0.007 \leq \frac{NOL ( {θ}_{2} ) - NOL ( {θ}_{1} )}{sin ( {θ}_{2} ) - sin ( {θ}_{1} )} \leq 0.007 , \\ - 0.006 \leq \frac{NOL ( {θ}_{2} ) - NOL ( {θ}_{1} )}{sin ( {θ}_{2} ) - sin ( {θ}_{1} )} \leq 0.006 , \\ or \\ - 0.005 \leq \frac{NOL ( {θ}_{2} ) - NOL ( {θ}_{1} )}{sin ( {θ}_{2} ) - sin ( {θ}_{1} )} \leq 0.005$$

for light having a wavelength of 450 nm and for light having a wavelength of more than 450 nm, for example for light having a wavelength in a range of from 450 nm to 760 nm, such as from 450 nm to 500 nm, from 500 nm to 610 nm and/or from 610 nm to 760 nm.

In some embodiments NOL(θ_{mid}) is smaller than 0.02, such as smaller than 0.018, smaller than 0.016, smaller than 0.014, smaller than 0.012, smaller than 0.01, smaller than 0.009, smaller than 0.008, smaller than 0.007, smaller than 0.006, smaller than 0.005, smaller than 0.004, smaller than 0.003 for light having a wavelength of 450 nm and for light having a wavelength of less than 450 nm, for example for light having a wavelength in a range of from 400 nm to 450 nm. NOL(θ_{mid}) may be at least 0.00001 or at least 0.00002 for light having a wavelength of 450 nm and for light having a wavelength of less than 450 nm, for example for light having a wavelength in a range of from 400 nm to 450 nm.

In some embodiments provided according to the present invention,

$$\frac{NOL ( {θ}_{2} ) - NOL ( {θ}_{1} )}{sin ( {θ}_{2} ) - sin ( {θ}_{1} )}$$

is at most 0.03, such as at most 0.025, at most 0.02, at most 0.015, at most 0.01, at most 0.009, at most 0.008, at most 0.007, at most 0.006, or at most 0.005 for light having a wavelength of 450 nm and for light having a wavelength of less than 450 nm, for example for light having a wavelength in a range of from 400 nm to 450 nm. In some embodiments,

$$\frac{NOL ( {θ}_{2} ) - NOL ( {θ}_{1} )}{sin ( {θ}_{2} ) - sin ( {θ}_{1} )}$$

may be at least 0.00001 or at least 0.00002 for light having a wavelength of 450 nm and for light having a wavelength of less than 450 nm, for example for light having a wavelength in a range of from 400 nm to 450 nm.

In some embodiments provided according to the present invention,

$$\frac{NOL ( {θ}_{2} ) - NOL ( {θ}_{1} )}{sin ( {θ}_{2} ) - sin ( {θ}_{1} )}$$

is at least −0.03, such as at least −0.025, at least −0.02, at least −0.015, at least −0.01, at least −0.009, at least −0.008, at least −0.007, at least −0.006, at least −0.005 for light having a wavelength of 450 nm and for light having a wavelength of less than 450 nm, for example for light having a wavelength in a range of from 400 nm to 450 nm. In some embodiments,

$$\frac{NOL ( {θ}_{2} ) - NOL ( {θ}_{1} )}{sin ( {θ}_{2} ) - sin ( {θ}_{1} )}$$

may be at most −0.001 or at most −0.002 for light having a wavelength of 450 nm and for light having a wavelength of less than 450 nm, for example for light having a wavelength in a range of from 400 nm to 450 nm.

In some embodiments provided according to the present invention, there is

$$- 0.03 \leq \frac{NOL ( {θ}_{2} ) - NOL ( {θ}_{1} )}{sin ( {θ}_{2} ) - sin ( {θ}_{1} )} \leq 0.03 , \\ such as \\ - 0.025 \leq \frac{NOL ( {θ}_{2} ) - NOL ( {θ}_{1} )}{sin ( {θ}_{2} ) - sin ( {θ}_{1} )} \leq 0.025 , \\ - 0.02 \leq \frac{NOL ( {θ}_{2} ) - NOL ( {θ}_{1} )}{sin ( {θ}_{2} ) - sin ( {θ}_{1} )} \leq 0.02 , \\ - 0.015 \leq \frac{NOL ( {θ}_{2} ) - NOL ( {θ}_{1} )}{sin ( {θ}_{2} ) - sin ( {θ}_{1} )} \leq 0.015 , \\ - 0.01 \leq \frac{NOL ( {θ}_{2} ) - NOL ( {θ}_{1} )}{sin ( {θ}_{2} ) - sin ( {θ}_{1} )} \leq 0.01 , \\ - 0.009 \leq \frac{NOL ( {θ}_{2} ) - NOL ( {θ}_{1} )}{sin ( {θ}_{2} ) - sin ( {θ}_{1} )} \leq 0.009 , \\ - 0.008 \leq \frac{NOL ( {θ}_{2} ) - NOL ( {θ}_{1} )}{sin ( {θ}_{2} ) - sin ( {θ}_{1} )} \leq 0.008 , \\ - 0.007 \leq \frac{NOL ( {θ}_{2} ) - NOL ( {θ}_{1} )}{sin ( {θ}_{2} ) - sin ( {θ}_{1} )} \leq 0.007 , \\ - 0.006 \leq \frac{NOL ( {θ}_{2} ) - NOL ( {θ}_{1} )}{sin ( {θ}_{2} ) - sin ( {θ}_{1} )} \leq 0.006 , \\ or \\ - 0.005 \leq \frac{NOL ( {θ}_{2} ) - NOL ( {θ}_{1} )}{sin ( {θ}_{2} ) - sin ( {θ}_{1} )} \leq 0.005$$

for light having a wavelength of 450 nm and for light having a wavelength of less than 450 nm, for example for light having a wavelength in a range of from 400 nm to 450 nm.

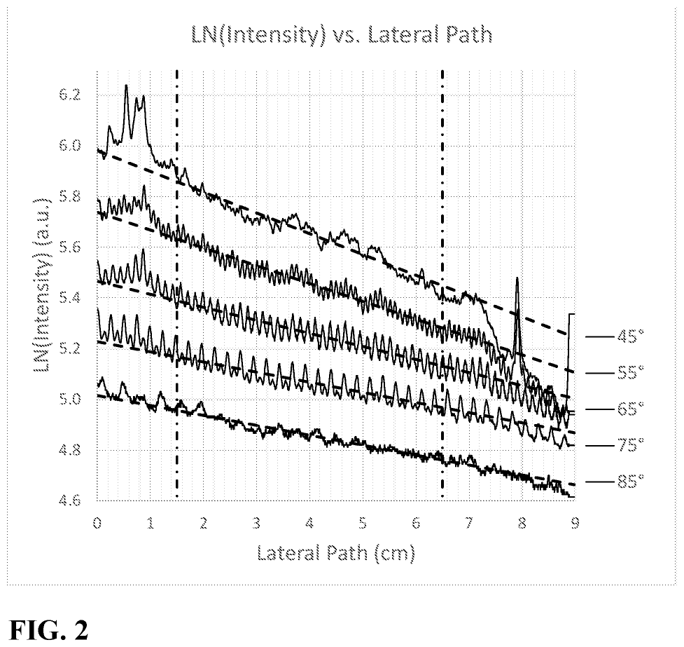

As shown in FIGS. 2 and 4 to 7, the detected light intensity periodically increases and decreases depending on the distance of the light from the main surface of the glass article at which the detecting fiber is positioned. The respective frequency is dependent on the propagation angle (the smaller the propagation angle, the greater the frequency) and on the wafer thickness. Moreover, the detected intensity decreases with increasing lateral position of the detecting fiber. This is due to optical loss α upon propagation of the light through the glass article and can be used for determining the optical loss α by simply calculating the linear slope of the curve in logarithmic scale (logarithmic light intensity curve). The logarithmic light intensity curve shows the natural logarithm of the light intensity detected by the optical fiber on the y-axis and the corresponding lateral path position xᵢ of the optical fiber on the x-axis.

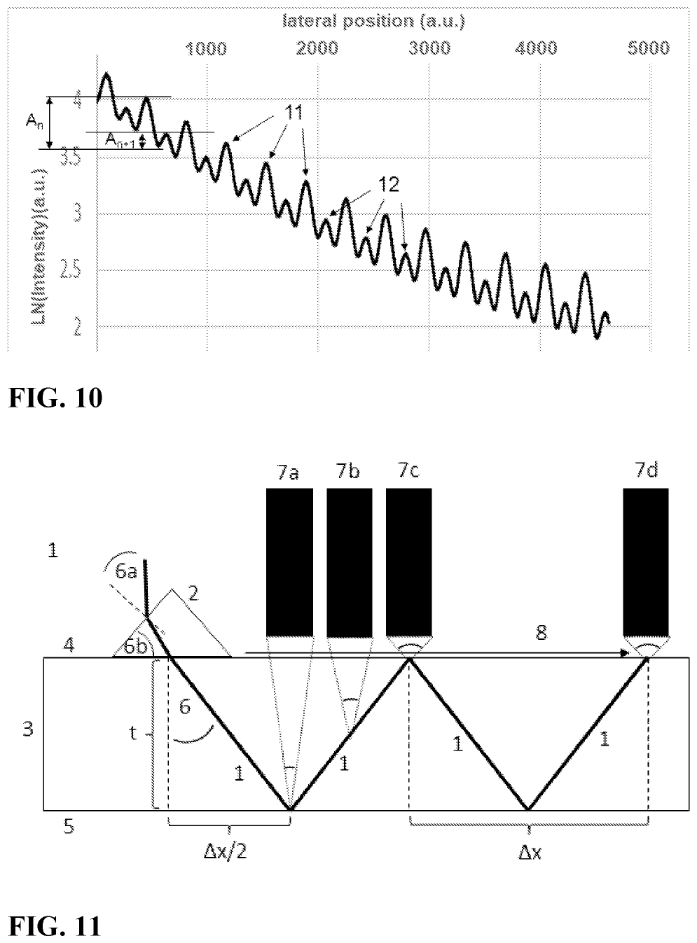

The distance of maxima caused by pure volume scattering can be calculated based on geometrical considerations. As described above, the detected light intensity periodically increases and decreases depending on the distance of the light from the main surface of the glass article at which the detecting fiber is positioned. Referring to FIGS. 1 and 11, when the fiber is in a position such that the light propagating through the article is close to the second main surface 5, the detection angle is small and therefore the detected light intensity is low 7a. In contrast, when the fiber is in a position such that the light propagating through the article is close to the main surface 4, the detection angle is large and therefore the detected light intensity is great 7c. Hence, lateral path position of fiber 7c corresponds to a maximum of light intensity. The next maximum of this kind is observed at a lateral path position of the detecting fiber such that the light propagating through the article is again close to the main surface 4 so that the detection angle is large and therefore the detected light intensity is great 7d. The respective maxima caused by pure volume scattering are called “principal local maxima”. The distance Δx of two neighboring principal local maxima can be computed as Δx=2*t*tan(θ) with t being the thickness of the article and θ being the propagation angle as illustrated in FIG. 11.

However, the logarithmic light intensity curves may contain additional local maxima due to surface scattering phenomena. Additional local maxima are absent in case of pure volume scattering.

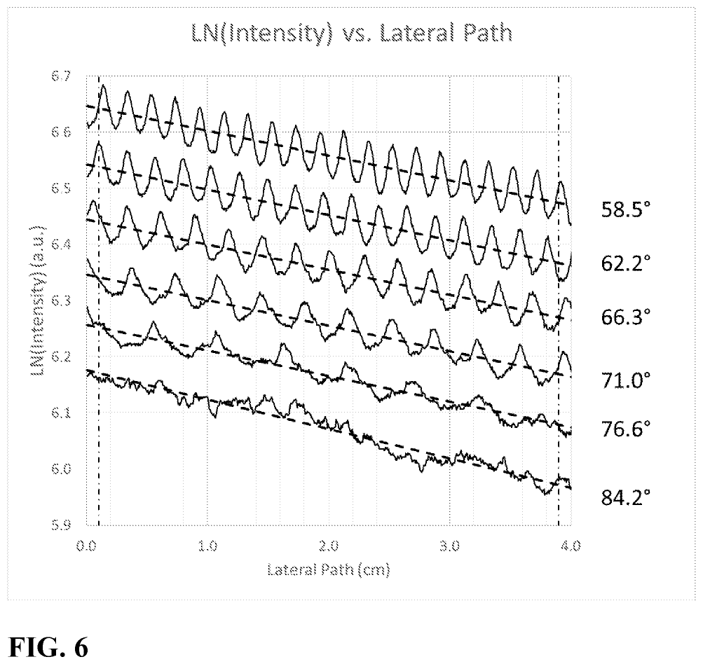

Surface scattering phenomena at both surfaces, in particular due to surface roughness and/or SSDs, result in an additional signal in the intensity having double frequency. The dependence of light intensity from the lateral path position xᵢ can be fitted based on the sum of two sinus functions as follows (see also FIG. 8): A·sin(x)+B·sin(2x).

The corresponding light intensity curve is characterized by alternating principal local maxima and secondary local maxima (FIGS. 2, 4 and 5). Generally, a principal local maximum has a higher intensity as compared to the intensity of a secondary local maximum. If secondary local maxima are present, the course of maxima in the logarithmic light intensity curve can be described as: . . . principal local maximum-secondary local maximum-principal local maximum-secondary local maximum-principal local maximum . . .

Interestingly, the occurrence of secondary maxima can be observed particularly well at propagation angles in a range of from 65° to 80°, in particular from 65° to 70° and/or from 75° to 80°, for example at propagation angles of about 66.3°, and/or about 77.5° (FIGS. 2, 4 and 5).

The height Aₙ₊₁ of a secondary local maximum as compared to the height Aₙ of a corresponding principal local maximum is a measure for the extent of surface scattering. The higher the height Aₙ₊₁ of the secondary local maximum is (as compared to the height Aₙ of the principal local maximum) for a given propagation angle θ, the higher is the extent of surface scattering. High surface scattering is disadvantageous for several reasons as described above. In some embodiments, the present invention provides glass articles having no secondary local maxima or having secondary local maxima with particularly low height Aₙ₊₁ as compared to the height Aₙ of the corresponding principal local maximum. In some embodiments, the glass article may be characterized by absence of a secondary local maximum having a height Aₙ₊₁ which is more than 50%, such as more than 45%, more than 40%, more than 35%, more than 30%, more than 25%, more than 20%, more than 15%, more than 10%, more than 5%, more than 2%, or more than 1% of the height Aₙ of the corresponding principal local maximum for any sequence maxₙ−minₙ−maxₙ₊₁ with x(maxₙ)>0.4 cm and with x(maxₙ₊₁)<2.0 cm in the logarithmic light intensity curve for at least one propagation angle θ in a range of from 65° to 80°, in particular for at least one propagation angle θ in a range of from 65° to 70° and/or a range of from 75° to 80°, for example for a propagation angle of about 66.3° and/or about 77.5°. In other words, z % may, for example, be 50%, 45%, 40%, 35%, 30%, 25%, 20%, 15%, 10%, 5%, 2%, or 1%.

In some embodiments, the glass article may be characterized by absence of a secondary local maximum having a height Aₙ−pi which is more than 50%, more than 45%, more than 40%, more than 35%, more than 30%, more than 25%, more than 20%, more than 15%, more than 10%, more than 5%, more than 2%, or more than 1% of the height Aₙ of the corresponding principal local maximum for any sequence maxₙ−minₙ−maxₙ₊₁ with x(maxₙ)>0.4 cm and with x(maxₙ₊₁)<2.0 cm in the logarithmic light intensity curve for any propagation angle θ in a range of from 65° to 70° and/or from 75° to 80°.

In some embodiments, the glass article may be characterized by absence of a secondary local maximum having a height Aₙ₊₁ which is more than 50%, more than 45%, more than 40%, more than 35%, more than 30%, more than 25%, more than 20%, more than 15%, more than 10%, more than 5%, more than 2%, or more than 1% of the height Aₙ of the corresponding principal local maximum for any sequence maxₙ−minₙ−maxₙ₊₁ with x(maxₙ)>0.4 cm and with x(maxₙ₊₁)<2.0 cm in the logarithmic light intensity curve for any propagation angle θ in a range of from 65° to 80°.

In some embodiments, there is x(maxₙ₊₁)<2.5 cm, x(maxₙ₊₁)<3.0 cm, x(maxₙ₊₁)<3.5 cm, x(maxₙ₊₁)<4.0 cm, x(maxₙ₊₁)<4.5 cm, x(maxₙ₊₁)<5.0 cm, x(maxₙ₊₁)<5.5 cm, x(maxₙ₊₁) <6.0 cm, x(maxₙ₊₁)<6.5 cm, x(maxₙ₊₁)<7.0 cm, x(maxₙ₊₁)<7.5 cm, x(maxₙ₊₁)<8.0 cm, x(maxₙ₊₁)<8.5 cm, or x(maxₙ₊₁)<9.0 cm.

In some embodiments, the glass article may be characterized by absence of a secondary local maximum having a height Aₙ₊₁ which is more than 50%, more than 45%, more than 40%, more than 35%, more than 30%, more than 25%, more than 20%, more than 15%, more than 10%, more than 5%, more than 2%, or more than 1% of the height Aₙ of the corresponding principal local maximum for any sequence maxₙ−minₙ−maxₙ₊₁ with x(maxₙ)>0.4 cm and with x(maxₙ₊₁)<2.0 cm in the logarithmic light intensity curve for any propagation angle θ in a range of from 65° to 70° and/or a range of from 75° to 80°, for example for a propagation angle of about 66.3° and/or about 77.5°.

In some embodiments, the article may be characterized by absence of any secondary local maximum having a height Aₙ₊₁ with Aₙ₊₁>z %*An*(325 μm/t), provided that the article thickness t >325 μm. For example, the article may be characterized by absence of a secondary local maximum having a height Aₙ₊₁ with Aₙ₊₁>50%*Aₙ*(325 μm/t), Aₙ₊₁>45%*Aₙ*(325/t), Aₙ₊₁>40%*An*(325 μm/t), Aₙ₊₁>35%*An*(325 μm/t), Aₙ₊₁>30%*An*(325 μm/t), Aₙ₊₁>25%*An*(325 μm/t), Aₙ₊₁>20%*An*(325 μm/t), Aₙ₊₁>15%*An*(325 μm/t), Aₙ₊₁>10%*Aₙ*(325 μm/t), Aₙ₊₁>5%*An*(325 μm/t), Aₙ₊₁>2%*An*(325 μm/t), or Aₙ₊₁>1%*Aₙ*(325 μm/t) for any sequence maxₙ−minₙ−maxₙ₊₁ with x(maxₙ)>0.4 cm and with x(maxₙ₊₁)<2.0 cm in a logarithmic light intensity curve for at least one propagation angle θ in a range of from 65° to 80°, in particular for at least one propagation angle θ in a range of from 65° to 70° and/or a range of from 75° to 80°, for example for a propagation angle of about 66.3° and/or about 77.5°. The article may be characterized by absence of a secondary local maximum having a height Aₙ₊₁ with Aₙ₊₁>50%*Aₙ*(325 μm/t), Aₙ₊₁>45%*An*(325 μm/t), Aₙ₊₁>40%*Aₙ*(325 μm/t), Aₙ₊₁>35%*An*(325 μm/t), Aₙ₊₁>30%*An*(325 μm/t), Aₙ₊₁>25%*Aₙ*(325 μm/t), Aₙ₊₁>20%*An*(325 μm/t), Aₙ₊₁>15%*An*(325 μm/t), Aₙ₊1>10%*Aₙ*(325 μm/t), Aₙ₊₁>5%*An*(325 μm/t), Aₙ₊₁>2%*An*(325 μm/t), or Aₙ₊1>1%*Aₙ*(325 μm/t) for any sequence maxₙ−minₙ−maxₙ₊₁ with x(maxₙ)>0.4 cm and with x(maxₙ₊₁)<2.0 cm in a logarithmic light intensity curve for any propagation angle θ in a range of from 65° to 70° and/or a range of from 75° to 80°, in particular for any propagation angle θ in a range of from 65° to 80°.

In some embodiments, the glass provided according to the present invention has a Knoop hardness Hk in a range of from 2 GPa to 10 GPa, such as from 2.5 GPa to 9.5 GPa, from 3 GPa to 9 GPa, from 3.5 GPa to 8.5 GPa, or from 4 to 8 GPa. The Knoop hardness Hk is a measure for permanent surface alterations upon indentation with a diamond indenter. The Knoop hardness Hk may be determined according to ISO 9385. In some embodiments, the Knoop hardness Hk is determined for an indentation force of 0.9807 N (i.e. 0.1 kp) and indentation time of 20 seconds. In some embodiments, the Knoop hardness Hk is determined using polished glass surfaces at room temperature.

Surprisingly it was found that the optical loss can be reduced by increasing the Young's modulus. In some embodiments, the glasses provided according to the present invention have a Young's modulus in the range of from 60 to 160 GPa, for example from 70 to 150 GPa or from 80 to 140 GPa.

In some embodiments, the refractive index n of the glass at a wavelength of 450 nm is in a range of from 1.45 to 2.45, such as from 1.50 to 2.40, from 1.55 to 2.35, from 1.60 to 2.30, from 1.65 to 2.25, from 1.70 to 2.20, for example from 1.75 to 2.15, from 1.80 to 2.10, from 1.85 to 2.05, from 1.86 to 2.04, from 1.87 to 2.03, from 1.88 to 2.02, from 1.89 to 2.01, or from 1.90 to 2.00. In some embodiments, the refractive index n of the glass at a wavelength of 450 nm is in a range of from 1.70 to 2.00.

In some embodiments, the glass article provided according to the present invention is a glass wafer. The glass article may be a rectangular-shaped glass wafer, for example having a length in a range of from 40 mm to 1,250 mm and a width of from 30 mm to 750 mm. However, in some embodiments the glass article is not rectangular-shaped but round-shaped, in particular a round-shaped glass wafer. A round-shaped glass wafer may also be described as disc-like glass wafer. In some embodiments, the glass article is a disc-like glass wafer, such as a glass wafer having a diameter in the range of from 100 mm to 500 mm, such as from 120 mm to 450 mm, from 140 mm to 400 mm, from 160 mm to 350 mm, from 180 mm to 325 mm, or from 200 mm to 300 mm. A diameter of about 200 mm or about 300 mm may be provided. In some embodiments, the diameter of the article is at least 100 mm, at least 120 mm, at least 140 mm, at least 160 mm, at least 180 mm or at least 200 mm. In some embodiments, the diameter of the article is at most 500 mm, such as at most 450 mm, at most 400 mm, at most 350 mm, at most 325 mm, or at most 300 mm.

In some embodiments, the thickness d of the article is in a range of from 0.10 mm to 2.0 mm, such as from 0.15 mm to 1.5 mm, from 0.20 mm to 1.2 mm, from 0.25 mm to 1.0 mm, from 0.30 mm to 0.70 mm, for example from 0.40 mm to 0.60 mm. Low thicknesses are advantageous with respect to the weight of the glass article. However, there may be disadvantages regarding surface and geometrical properties that may impair light propagation based on total internal reflection, for example by increasing optical loss and/or dependence of optical loss from the propagation angle. Therefore, the above-indicated ranges are exemplary.

In some embodiments, the ratio of diameter and thickness of the article is in a range of from 200:1 to 2,000:1, for example from 350:1 to 1,500:1 or from 500:1 to 1,000:1.

The glass articles provided according to the present invention may be glass wafers, in particular planar glass wafers such as planar waveguides.

In some embodiments, the glass articles provided according to the present invention have a low warp, in particular a warp of less than 100 μm, such as of less than 50 μm, or less than 20 μm. The warp may be more than 1 μm, more than 5 μm or more than 10 μm. In some embodiments, the glass articles provided according to the present invention have a low bow, in particular a bow of less than 100 μm, such as less than 50 μm, or less than 20 μm. The bow may be more than 1 μm, more than 5 μm or more than 10 μm. Warp and/or bow of the glass articles may be influenced by diameter and thickness of the articles as well as by coatings. In some embodiments, warp and/or bow of the articles provided according to the present invention are less than 0.1% of the article diameter, such as less than 0.075% of the article diameter, less than 0.05% of the article diameter, less than 0.025% of the article diameter, or less than 0.01% of the article diameter. Warp and/or bow may be more than 0.001% of the article diameter, more than 0.002% of the article diameter or more than 0.005% of the article diameter. In some embodiments, warp and bow are determined according to SEMI3D1203152015.

In some embodiments, the TTV (Total Thickness Variation) of the glass article is smaller than 2 μm, smaller than 1.8 μm, smaller than 1.6 μm, smaller than 1.5 μm, smaller than 1.4 μm, smaller than 1.3 μm, smaller than 1.2 μm, smaller than 1.1 μm, smaller than 1.0 μm, smaller than 0.75 μm, or smaller than 0.5 TTV may be determined based on SEMI MF 1530GBIR. TTV may also be determined based on interferometric measurements of the thickness profile of the glass article, for example using an interferometer, in particular an interferometer of Zygo Corporation. In some embodiments, TTV may be at least 0.1 μm or at least 0.2 μm. A very low TTV may be advantageous for use of the article in the AR field. A low TTV may, for example, be obtained by abrasive processes such as grinding, lapping and/or polishing. Thus, the article provided according to the present invention may be an article that an abrasive process has been applied to. However, abrasive processes may result in SSDs and therefore impairments regarding normalized optical loss NOL and/or dependence of NOL from the propagation angle θ. Introduction of SSDs may, for example, be reduced by choosing glasses having comparably high fracture toughness Kip. It is a particular advantage that may be provided according to the present invention to combine a low TTV with a low NOL and a low dependence of NOL from the propagation angle.

The article provided according to the present invention may also be characterized by particularly parallel main surfaces. This may be described in terms of “maximum local slope”. In particular, the maximum local slope of the article may be less than 2 arcsec, less than 1.5 arcsec, less than 1 arcsec, less than 0.75 arcsec, less than 0.5 arcsec, less than 0.25 arcsec, or less than 0.15 arcsec. The maximum local slope of the article may be more than 0.01 arcsec, more than 0.05 arcsec or more than 0.1 arcsec. The local slope may be determined based on interferometric measurements of the thickness profile of the glass article, for example using an interferometer, in particular an interferometer of Zygo Corporation. In particular, the local slope may be determined as the angle formed by the line connecting maximum thickness and minimum thickness within a defined lateral dimension. This lateral dimension may be in a range of from 1 to 5 mm, for example 1 mm, 2 mm, 3 mm, 4 mm or 5 mm. The local slope may be determined across the whole area of the wafer or across at least 50%, at least 60%, at least 70%, at least 80%, at least 90%, at least 95%, or at least 99% thereof, in particular across the whole quality area of the wafer, and the maximum value of the determined local slope values is the “maximum local slope of the wafer”.

In some embodiments, the article has a surface roughness R_{q} in a range of from 0.1 nm to 5 nm, for example from 0.15 nm to 3.5 nm, from 0.2 nm to 2 nm, from 0.25 nm to 1.5 nm, from 0.3 nm to 1.0 nm, or from 0.35 nm to 0.75 nm. In some embodiments, the surface roughness R_{q} is less than 5 nm, such as less than 3.5 nm, less than 2 nm, less than 1.5 nm, less than 1.0 nm, less than 0.75 nm, or less than 0.5 nm. A low surface roughness R_{q} may be advantageous for obtaining a low normalized optical loss NOL and/or a low dependence of NOL from propagation angle θ. Surface roughness R_{q} may be determined with white light interferometry (WLI) or atomic force microscopy (AFM). In the present disclosure, the terms “R_{q}” and “RMS” are used interchangeably. Surface roughness R_{q} may be determined according to DIN EN ISO 4287.

In some embodiments, the article has a surface roughness Rₐ in a range of from 0.1 nm to 5 nm, for example from 0.15 nm to 3.5 nm, from 0.2 nm to 2 nm, from 0.25 nm to 1.5 nm, from 0.3 nm to 1.0 nm, or from 0.35 nm to 0.75 nm. In some embodiments, the surface roughness Rₐ is less than 5 nm, such as less than 3.5 nm, less than 2 nm, less than 1.5 nm, less than 1.0 nm, less than 0.75 nm, or less than 0.5 nm. A low surface roughness Rₐ may be advantageous for obtaining a low normalized optical loss NOL and/or a low dependence of NOL from propagation angle θ. Surface roughness Rₐ may be determined according to ISO DIN EN ISO 4287.

The glass articles provided according to the present invention are not restricted to particular glass compositions. Exemplary composition ranges are presented in the following as mere examples.

The amount of SiO₂ in the articles provided according to the present invention may be in a range of from 0 to 80 wt.-%, for example at most 70 wt.-%, at most 60 wt.-% or at most 15 wt.-%. In some embodiments, the amount of SiO₂ is at least 10 wt.-%, at least 20 wt.-%, at least 30 wt.-% or at least 40 wt.-%. In some embodiments, the amount of SiO₂ is less than 20 wt.-% or even less than 10 wt.-%.

The amount of P₂O₅ in the articles provided according to the present invention may be in a range of from 0 to 40 wt.-%, for example at most 30 wt.-%, at most 5 wt.-% or at most 2 wt.-%. In some embodiments, the amount of P₂O₅ may be at least 10 wt.-%, at least 15 wt.-% or at least 20 wt.-%. In some embodiments, the amount of P₂O₅ is at most 1 wt.-%, or at most 0.5 wt.-%. The articles provided according to the present invention may also be free of P₂O₅.

The amount of Al₂O₃ in the articles provided according to the present invention may be in a range of from 0 to 25 wt.-%, for example at most 15 wt.-%, at most 10 wt.-%, or at most 5 wt.-%. In some embodiments, the amount of Al₂O₃ may be at least 0.1 wt.-%, at least 0.5 wt.-% or at least 1 wt.-%. In some embodiments, the amount of Al₂O₃ is at most 1 wt.-% or at most 0.5 wt.-%. The articles provided according to the present invention may also be free of Al₂O₃.

The amount of B₂O₃ in the articles provided according to the present invention may be in a range of from 0 to 55 wt.-%, for example at most 45 wt.-%, at most 35 wt.-%, or at most 25 wt.-%. In some embodiments, the amount of B₂O₃ may be at least 1 wt.-%, at least 2 wt.-%, or at least 5 wt.-%. In some embodiments, the amount of B₂O₃ is at most 20 wt.-%, at most 15 wt.-% or at most 10 wt.-%. The articles provided according to the present invention may also be free of B₂O₃.

The amount of Li₂O in the articles provided according to the present invention may be in a range of from 0 to 10 wt.-%, for example at most 5 wt.-%, at most 2 wt.-%, or at most 1 wt.-%. In some embodiments, the amount of Li₂O may be at least 0.5 wt.-%, at least 1 wt.-%, or at least 2 wt.-%. In some embodiments, the amount of Li₂O is at most 0.5 wt.-%, at most 0.2 wt.-% or at most 0.1 wt.-%. The articles provided according to the present invention may also be free of Li₂O.

The amount of Na₂O in the articles provided according to the present invention may be in a range of from 0 to 30 wt.-%, for example at most 25 wt.-%, at most 20 wt.-%, at most 10 wt.-%, or at most 5 wt.-%. In some embodiments, the amount of Na₂O may be at least 1 wt.-%, at least 2 wt.-%, or at least 5 wt.-%. In some embodiments, the amount of Na₂O is at most 2 wt.-%, at most 1 wt.-% or at most 0.5 wt.-%. The articles provided according to the present invention may also be free of Na₂O.

The amount of K₂O in the articles provided according to the present invention may be in a range of from 0 to 25 wt.-%, for example at most 20 wt.-%, at most 10 wt.-%, or at most 5 wt.-%. In some embodiments, the amount of K₂O may be at least 1 wt.-%, at least 2 wt.-%, or at least 5 wt.-%. In some embodiments, the amount of K₂O is at most 2 wt.-%, at most 1 wt.-% or at most 0.5 wt.-%. The articles provided according to the present invention may also be free of K₂O.

The amount of MgO in the articles provided according to the present invention may be in a range of from 0 to 10 wt.-%, for example at most 5 wt.-%, at most 2 wt.-%, or at most 1 wt.-%. In some embodiments, the amount of MgO may be at least 0.5 wt.-%, at least 1 wt.-%, or at least 2 wt.-%. In some embodiments, the amount of MgO is at most 0.5 wt.-%, at most 0.2 wt.-% or at most 0.1 wt.-%. The articles provided according to the present invention may also be free of MgO.

The amount of CaO in the articles provided according to the present invention may be in a range of from 0 to 40 wt.-%, for example at most 30 wt.-%, at most 25 wt.-%, or at most 15 wt.-%. In some embodiments, the amount of CaO may be at least 1 wt.-%, at least 5 wt.-%, or at least 10 wt.-%. In some embodiments, the amount of CaO is at most 10 wt.-%, at most 5 wt.-%, or at most 1 wt.-%. The articles provided according to the present invention may also be free of CaO.

The amount of SrO in the articles provided according to the present invention may be in a range of from 0 to 25 wt.-%, for example at most 15 wt.-%, at most 10 wt.-%, or at most 5 wt.-%. In some embodiments, the amount of SrO may be at least 0.5 wt.-%, at least 1 wt.-%, or at least 2 wt.-%. In some embodiments, the amount of SrO is at most 2 wt.-%, at most 1 wt.-%, or at most 0.5 wt.-%. The articles provided according to the present invention may also be free of SrO.

The amount of BaO in the articles provided according to the present invention may be in a range of from 0 to 55 wt.-%, for example at most 30 wt.-%, at most 20 wt.-%, or at most 10 wt.-%. In some embodiments, the amount of BaO may be at least 1 wt.-%, at least 5 wt.-%, or at least 10 wt.-%. In some embodiments, the amount of BaO is at most 5 wt.-%, at most 2 wt.-%, or at most 1 wt.-%. The articles provided according to the present invention may also be free of BaO.

The amount of ZnO in the articles provided according to the present invention may be in a range of from 0 to 30 wt.-%, for example at most 20 wt.-%, at most 15 wt.-%, or at most 10 wt.-%. In some embodiments, the amount of ZnO may be at least 1 wt.-%, at least 2 wt.-%, or at least 5 wt.-%. In some embodiments, the amount of ZnO is at most 5 wt.-%, at most 2 wt.-%, or at most 1 wt.-%. The articles provided according to the present invention may also be free of ZnO.

The amount of La₂O₃ in the articles provided according to the present invention may be in a range of from 0 to 55 wt.-%, for example at most 50 wt.-%, at most 40 wt.-%, or at most 20 wt.-%. In some embodiments, the amount of La₂O₃ may be at least 5 wt.-%, at least 10 wt.-%, or at least 20 wt.-%. In some embodiments, the amount of La₂O₃ is at most 10 wt.-%, at most 5 wt.-%, or at most 1 wt.-%. The articles provided according to the present invention may also be free of La₂O₃.

The amount of Gd₂O₃ in the articles provided according to the present invention may be in a range of from 0 to 20 wt.-%, for example at most 15 wt.-%, at most 10 wt.-%, or at most 5 wt.-%. In some embodiments, the amount of Gd₂O₃ may be at least 1 wt.-%, at least 2 wt.-%, or at least 5 wt.-%. In some embodiments, the amount of Gd₂O₃ is at most 5 wt.-%, at most 2 wt.-%, or at most 1 wt.-%. The articles provided according to the present invention may also be free of Gd₂O₃.

The amount of Y₂O₃ in the articles provided according to the present invention may be in a range of from 0 to 20 wt.-%, for example at most 15 wt.-%, at most 10 wt.-%, or at most 5 wt.-%. In some embodiments, the amount of Y₂O₃ may be at least 0.1 wt.-%, at least 0.2 wt.-%, or at least 0.5 wt.-%. In some embodiments, the amount of Y₂O₃ is at most 2 wt.-%, at most 1 wt.-%, or at most 0.5 wt.-%. The articles provided according to the present invention may also be free of Y₂O₃.

The amount of ZrO₂ in the articles provided according to the present invention may be in a range of from 0 to 20 wt.-%, for example at most 15 wt.-%, at most 10 wt.-%, or at most 5 wt.-%. In some embodiments, the amount of ZrO₂ may be at least 1 wt.-%, at least 2 wt.-%, or at least 5 wt.-%. In some embodiments, the amount of ZrO₂ is at most 7.5 wt.-%, at most 5 wt.-%, or at most 2.5 wt.-%. The articles provided according to the present invention may also be free of ZrO₂.

The amount of TiO₂ in the articles provided according to the present invention may be in a range of from 0 to 35 wt.-%, for example at most 30 wt.-%, at most 20 wt.-%, or at most 15 wt.-%. In some embodiments, the amount of TiO₂ may be at least 2 wt.-%, at least 5 wt.-%, or at least 10 wt.-%. In some embodiments, the amount of TiO₂ is at most 10 wt.-%, at most 7.5 wt.-%, or at most 5 wt.-%. The articles provided according to the present invention may also be free of TiO₂.

The amount of Ta₂O₅ in the articles provided according to the present invention may be in a range of from 0 to 30 wt.-%, for example at most 25 wt.-%, at most 17.5 wt.-%, or at most 10 wt.-%. In some embodiments, the amount of Ta₂O₅ may be at least 1 wt.-%, at least 2 wt.-%, or at least 5 wt.-%. In some embodiments, the amount of Ta₂O₅ is at most 5 wt.-%, at most 2 wt.-%, or at most 1 wt.-%. The articles provided according to the present invention may also be free of Ta₂O₅.

The amount of Nb₂O₅ in the articles provided according to the present invention may be in a range of from 0 to 55 wt.-%, for example at most 35 wt.-%, at most 20 wt.-%, or at most 15 wt.-%. In some embodiments, the amount of Nb₂O₅ may be at least 2 wt.-%, at least 5 wt.-%, or at least 10 wt.-%. In some embodiments, the amount of Nb₂O₅ is at most 10 wt.-%, at most 5 wt.-%, or at most 2 wt.-%. The articles provided according to the present invention may also be free of Nb₂O₅.

The amount of WO₃ in the articles provided according to the present invention may be in a range of from 0 to 10 wt.-%, for example at most 7.5 wt.-%, at most 5 wt.-%, or at most 2 wt.-%. In some embodiments, the amount of WO₃ may be at least 0.1 wt.-%, at least 0.2 wt.-%, or at least 0.5 wt.-%. In some embodiments, the amount of WO₃ is at most 1 wt.-%, at most 0.5 wt.-%, or at most 0.2 wt.-%. The articles provided according to the present invention may also be free of WO₃.

The amount of Bi₂O₃ in the articles provided according to the present invention may be in a range of from 0 to 65 wt.-%, for example at most 50 wt.-%, at most 20 wt.-%, or at most 10 wt.-%. In some embodiments, the amount of Bi₂O₃ may be at least 1 wt.-%, at least 2 wt.-%, or at least 5 wt.-%. In some embodiments, the amount of Bi₂O₃ is at most 5 wt.-%, at most 1 wt.-%, or at most 0.1 wt.-%. The articles provided according to the present invention may also be free of Bi₂O₃.

The amount of F in the articles provided according to the present invention may be in a range of from 0 to 45 wt.-%, for example at most 25 wt.-%, at most 10 wt.-%, or at most 5 wt.-%. In some embodiments, the amount of F may be at least 0.1 wt.-%, at least 0.5 wt.-%, or at least 1 wt.-%. In some embodiments, the amount of F is at most 2 wt.-%, at most 1 wt.-%, or at most 0.1 wt.-%. The articles provided according to the present invention may also be free of F.

The amount of GeO₂ in the articles provided according to the present invention may be in a range of from 0 to 20 wt.-%, for example at most 15 wt.-%, at most 10 wt.-%, or at most 5 wt.-%. In some embodiments, the amount of GeO₂ may be at least 0.1 wt.-%, at least 0.5 wt.-%, or at least 1 wt.-%. In some embodiments, the amount of GeO₂ is at most 2 wt.-%, at most 1 wt.-%, or at most 0.1 wt.-%. The articles provided according to the present invention may also be free of GeO₂.

The amount of PbO in the articles provided according to the present invention may be in a range of from 0 to 80 wt.-%, for example at most 70 wt.-%, at most 50 wt.-%, or at most 20 wt.-%. In some embodiments, the amount of PbO may be at least 1 wt.-%, at least 2 wt.-%, or at least 5 wt.-%. In some embodiments, the amount of PbO is at most 5 wt.-%, at most 1 wt.-%, or at most 0.1 wt.-%. The articles provided according to the present invention may also be free of PbO in particular in view of the toxicity and environmental unfriendliness thereof.

In some embodiments, the glass articles provided according to the present invention comprise (or essentially consist of) the following components in the indicated ranges (in wt.-%):

| Component | Amount (wt.-%) |
|---|---|
| SiO₂ | 0-80 |
| P₂O₅ | 0-40 |
| Al₂O₃ | 0-25 |
| B₂O₃ | 0-55 |
| Li₂O | 0-10 |
| Na₂O | 0-25 |
| K₂O | 0-25 |
| MgO | 0-10 |
| CaO | 0-30 |
| SrO | 0-25 |
| BaO | 0-55 |
| ZnO | 0-30 |
| La₂O₃ | 0-55 |
| Gd₂O₃ | 0-20 |
| Y₂O₃ | 0-20 |
| ZrO₂ | 0-20 |
| TiO₂ | 0-35 |
| Ta₂O₅ | 0-30 |
| Nb₂O₅ | 0-55 |
| WO₃ | 0-10 |
| GeO₂ | 0-20 |
| Bi₂O₃ | 0-65 |
| PbO | 0-80 |
| F | 0-45 |

In some embodiments, the glass articles provided according to the present invention comprise (or essentially consist of) the following components in the indicated ranges (in wt.-%):

| Component | Amount (wt.-%) |
|---|---|
| SiO₂ | 0-80 |
| P₂O₅ | 0-30 |
| Al₂O₃ | 0-15 |
| B₂O₃ | 0-55 |
| Li₂O | 0-10 |
| Na₂O | 0-25 |
| K₂O | 0-25 |
| MgO | 0-5 |
| CaO | 0-30 |
| SrO | 0-10 |
| BaO | 0-55 |
| ZnO | 0-30 |
| La₂O₃ | 0-55 |
| Gd₂O₃ | 0-20 |
| Y₂O₃ | 0-20 |
| ZrO₂ | 0-20 |
| TiO₂ | 0-35 |
| Ta₂O₅ | 0-30 |
| Nb₂O₅ | 0-55 |
| WO₃ | 0-10 |
| GeO₂ | essentially free of |
| Bi₂O₃ | essentially free of |
| PbO | 0-70 |
| F | 0-25 |

In some embodiments, the glass articles provided according to the present invention comprise (or essentially consist of) the following components in the indicated ranges (in wt.-%):

| Component | Amount (wt.-%) |
|---|---|
| SiO₂ | 0-80 |
| P₂O₅ | 0-5 |
| Al₂O₃ | 0-10 |
| B₂O₃ | 0-45 |
| Li₂O | 0-10 |
| Na₂O | 0-20 |
| K₂O | 0-20 |
| MgO | 0-5 |
| CaO | 0-30 |
| SrO | 0-10 |
| BaO | 0-55 |
| ZnO | 0-30 |
| La₂O3 | 0-55 |
| Gd₂O₃ | 0-20 |
| Y₂O₃ | 0-20 |
| ZrO₂ | 0-20 |
| TiO₂ | 0-35 |
| Ta₂O₅ | 0-30 |
| Nb₂O₅ | 0-35 |
| WO₃ | 0-10 |
| GeO₂ | essentially free of |
| Bi₂O₃ | essentially free of |
| PbO | essentially free of |
| F | 0-5 |

In some embodiments, the glass articles provided according to the present invention comprise (or essentially consist of) the following components in the indicated ranges (in wt.-%):

| Component | Amount (wt.-%) |
|---|---|
| SiO₂ | 0-60 |
| P₂O₅ | 0-2 |
| Al₂O₃ | 0-5 |
| B₂O₃ | 0-45 |
| Li₂O | 0-10 |
| Na₂O | 0-10 |
| K₂O | 0-10 |
| MgO | 0-5 |
| CaO | 0-30 |
| SrO | 0-10 |
| BaO | 0-30 |
| ZnO | 0-30 |
| La₂O₃ | 0-55 |
| Gd₂O₃ | 0-20 |
| Y₂O₃ | 0-20 |
| ZrO₂ | 0-15 |
| TiO₂ | 0-20 |
| Ta₂O₅ | 0-25 |
| Nb₂O₅ | 0-20 |
| WO₃ | 0-5 |
| GeO₂ | essentially free of |
| Bi₂O₃ | essentially free of |
| PbO | essentially free of |
| F | essentially free of |

In some embodiments, the glass articles provided according to the present invention comprise (or essentially consist of) the following components in the indicated ranges (in wt.-%):

| Component | Amount (wt.-%) |
|---|---|
| SiO₂ | 0-15 |
| P₂O₅ | essentially free of |
| Al₂O₃ | essentially free of |
| B₂O₃ | 0-45 |
| Li₂O | essentially free of |
| Na₂O | essentially free of |
| K₂O | essentially free of |
| MgO | essentially free of |
| CaO | 0-15 |
| SrO | 0-5 |
| BaO | 0-10 |
| ZnO | 0-30 |
| La₂O₃ | 0-55 |
| Gd₂O₃ | 0-20 |
| Y₂O₃ | 0-20 |
| ZrO₂ | 0-10 |
| TiO₂ | 0-15 |
| Ta₂O₅ | 0-10 |
| Nb₂O₅ | 0-15 |
| WO₃ | 0-5 |
| GeO₂ | essentially free of |
| Bi₂O₃ | essentially free of |
| PbO | essentially free of |
| F | essentially free of |

The present invention also relates to a method of producing a glass article provided according to the present invention, the method comprising the following steps

Melting glass raw materials, and

Cooling the melt.

The method may further comprise the step of forming the melt prior to cooling the melt.

The method may further comprise the step of post-processing the glass article. For example, one or more cutting processes may be applied. In some embodiments, the method comprises one or more abrasive processes, in particular selected from grinding, lapping and polishing. This may be particularly advantageous for achieving a very low TTV. Furthermore, the surface roughness may be specifically adjusted.

Thus, the method may comprise one or more abrasive processes (which may be selected from the group consisting of grinding, lapping and polishing). However, abrasive processes may induce local stress in the surface of brittle glass material, resulting in SSDs. Therefore, the method may be balanced with respect to the abrasive processes such that they are made sufficiently for achieving a low TTV but not too much in order not to produce too much SSDs that would in turn increase both the normalized optical loss (NOL) and its dependence on the propagation angle.

For example, glass wafers may be processed by a double-side processing using planetary cinematics. In such machines, several wafers are processed in one batch, depending on size typically 10-30 wafers. In such machines, quality is based on statistical distribution within a batch and also varying from batch to batch due to interfering of several process conditions.

Exemplary process steps aim high removal rate, so for example grinding with diamond tools. The method may comprise polishing, in particular several steps, for example using polyurethane-pads, cerium-oxide slurry and a local load of approximately 30 g/cm². It is also possible to use soft pads (felt or others) using finest cerium-slurry (D97 like 1.5−3 microns) or finest diamond tools (grain size <0.1 microns).

Particular care should be taken with respect to SSDs upon abrasive processes as described above. If a particular low TTV is desired, it is also possible to use glasses having a higher fracture toughness K_{Ic} as these glasses are less sensitive for developing SSDs so that more stringent abrasive processes may be applied without compromising NOL and its dependence on propagation angle too much. It is also possible to use glasses having a higher refractive index.

The present invention also relates to the use of the glass article provided according to the present invention as a light guide plate, in particular in an augmented reality device.

The present invention also relates to an augmented reality device comprising a glass article provided according to the present invention.

### EXAMPLES

Optical loss was determined for five different glass articles A to E of two different glass compositions 1 and 2. Composition 1 is an alkali metal containing silicate glass composition comprising relevant amounts of BaO, TiO₂ and Nb₂O₅. Composition 2 is an alkali metal containing niobium phosphate glass composition comprising relevant amounts of BaO and TiO₂.

Articles A to E are planar glass wafers.

1. Examples A to C

Examples A to C are glass articles comprising a glass having a glass composition 1. The refractive index n at a wavelength of 450 nm was about 1.84.

Examples A to C differ from each other with respect to their surface roughness as shown in the following table. This was achieved by differing polishing parameters, in particular different polishing times. The surface roughness was determined by atomic force microscopy (AFM).

| | Example A | | Example B | | Example C | |
|---|---|---|---|---|---|---|
| Article thickness | 325 | μm | 325 | μm | 325 | μm |
| Article diameter | 150 | mm | 150 | mm | 150 | mm |
| TTV | 0.5 | μm | 0.5 | μm | 0.5 | μm |
| Surface roughness RMS | 0.34 | nm | 1.1 | nm | 3.7 | nm |

Optical loss of articles A to C was determined as follows using the Prism Coupler Tool “Metricon”, Model 2010/M with prism type 200-P-2 and with waveguide loss measurement option (see also FIG. 1).

Laser light of 450 nm wavelength was coupled into each of the articles A to C by a prism such that the light propagated inside the respective articles. An optical fiber was moved across the surface of the article in the direction of the propagating light beam for a lateral distance of 9 cm. The fiber detected the light which was scattered and thereby left the article. Scattering and absorbance led to a significant decrease of the detected light intensity along the propagation, following an exponential decay with the fiber's lateral path. The total optical losses can be evaluated by mathematically fitting the curve and calculating the decay coefficient. The graph “ln(Intensity) vs. “fiber position” is therefore plotted. Since the raw data follows an exponential decay, a linear decaying behavior is obtained by using the natural logarithm as can be seen in FIG. 2. Applying a simple linear least squares regression to the data, a single line f(x) is received, having a negative slope (dotted lines in FIG. 2). The linear function f(x) describes the dependency of the natural logarithm of the detected light intensity from the lateral path position x of the optical fiber. Because of possible artefacts in the beginning and at the end of the measurement, not all data of the lateral path have been taken but only the data of a reduced area in between, indicated by the two vertical chain-dotted lines. In order to transpose the fiber's lateral path into the optical path (OP) of the propagating beam, the data of the x axis is divided by the sinus of the propagation angle θ for each measurement. Finally, the optical loss for each propagation angle is determined based on the optical path by calculating the slope of the lines by the equation

$$α = \frac{ln ( {I}_{2} ) - ln ( {I}_{1} )}{{OP}_{2} - {OP}_{1}} ,$$

wherein I₂ and I₁ were the light intensities at lateral path positions x₂=6.5 cm and x₁=1.5 cm, respectively, and wherein OP₂ and OP₁ were the corresponding optical path positions determined as OP₂=x₂/sin(θ) and OP₁=x₁/sin(θ), respectively. Notably, the light intensities I₂ and I₁ are not necessarily identical to the actual light intensities as measured at x₂ and x₁, respectively. Rather, I₂ and I₁ were determined based on the linear regression of the experimentally determined data, i.e. ln (I₂)=f(x₂) and ln (I₁)=f(x₁).

Experimentally, at first the glass articles were cleaned in order to remove dust and potential other residuals at the surface. The clean article was then mounted into the Metricon tool as described in the manual (REV. (Feb. 1, 2003)) thereof. Briefly, the article was pressed against the prism's base by the so called “coupling head”, for example using a coupling pressure in a range of from 30 to 45 psi. If the article is correctly mounted, one can visually see the coupling spot, which is a circular shaped area at the prism's base occurring from the locally close contact of prism to the article, the spot having a diameter of approximately 1 to 2 mm. The following measurement was only performed if the coupling spot indicating correct mounting was observed.

The direction of the laser beam was adjusted by tilted mirrors in x and y direction to meet the coupling spot and to inject the beam into the article. To improve the usable lateral length for evaluation, the back reflection at the wafer's edge is canceled by darkening this edge with a black Edding pen. Prior to measure, the cover was applied to the cabin to avoid disturbing light from the surrounding area.

In order to firstly align the laser one can use any angle of incidence (AOI) of the beam with respect to the side area of the prism that leads to a propagation of the beam inside the substrate, e.g. 0°. By varying the tilted mirrors of the system in x- and y-direction, one can guide the laser beam to the coupling spot. Coupling is confirmed by an analog display that shows a signal different from zero. The optimal coupling position is found by carefully turning the x- and y-tilted mirrors sequentially to maximize the reading. In case the signal is too high, one has to reduce the gain factor by turning the corresponding knob.

Once that the maximum signal was found, the laser path was masked by the intrinsic shutter and the offset was set to zero. After setting the offset to zero, the shutter was opened again, and the signal amplification was adjusted such that the analog reading shows approximately 80%. The system was thereby set up to perform the measurement at the given AOI of 0°.

When changing the AOI, one has to align the laser beam onto the coupling spot again by adjusting the x- and y-mirror positions, increasing the analog reading to a maximum. Once the maximum reading is found, one has to check for the offset again and one can perform the measurement.

This alignment of x and y to achieve the maximum reading at different AOI leads to reliable results that can be compared with each other.

By definition, the AOI of 0=0° is given when the laser beam meets the side surface of the prism perpendicularly. The propagation angle θ can be calculated knowing the AOI β, the refractive index of the substrate n, the refractive index of the prism n₁ and the angle ω of the prism between the prism's base and the side where the beam enters the prism. The refractive index of air no is taken into account as 1. The propagation angle θ for a given AOI β is calculated according to

$$θ = arcsin ( \frac{{n}_{1}}{n} sin ( arcsin ( \frac{{n}_{0}}{{n}_{1}} sin ( β ) ) + ω ) )$$

To choose a certain propagation angle one can transpose the above equation to β:

$$β = arcsin ( \frac{{n}_{1}}{{n}_{0}} sin ( arcsin ( \frac{n}{{n}_{1}} sin ( θ ) ) - ω ) )$$

The possible range of propagation angles θ of the beam inside the article depends on the article's refractive index. Therefore, it may be preferred to use the term sin(θ) rather than the absolute angle. In case of the maximum propagation angle, the condition sin(θₘₐₓ)=1 is fulfilled. The minimum propagation angle is defined by the equation sin(θₘᵢₙ)=1/n, where n is the refractive index of the article. A medium angle can also be defined, given by sin(θ_{mid})=0.83. Since it is difficult to perform a measurement at the exact physical solutions of the equations, it was decided that the slope of the dependence of the normalized optical loss from the propagation angle θ is determined based on propagation angles θ₂ and θ₁, wherein θ₂ is a propagation angle with sin(θ₂)=0.98 and θ₁ is a propagation angle with sin(θ₁)=0.75. Thus, θ₁ and θ₂ are reasonably apart from each other and still θ₁ is not too close to θₘᵢₙ and θ₂ is not too close to θₘₐₓ. Regarding Examples B and C, the optical loss α was experimentally determined based on the measurements as indicated above for seven different propagation angles, wherein the sinus of the different propagation angles was in a range of from 0.69 to 0.93. Regarding Example A, the optical loss α was experimentally determined based on the measurements as indicated above for five different propagation angles from 45° to 85° such that the sinus of the different propagation angles was in a range of from >0.7 to <1.0.

The normalized optical loss NOL was determined by multiplying the optical loss α with the article thickness d. A linear fit was applied to the obtained data as shown in FIGS. 3A to 3C. NOL(θ₁), NOL(θ_{mid}) and NOL(θ₂) were estimated based on the linear fit. The results are shown in the following table.

| | Example A | Example B | Example C |
|---|---|---|---|
| NOL (θ₁) | 0.0018 | 0.0033 | 0.0067 |
| NOL (θ_{mid}) | 0.0015 | 0.0026 | 0.0034 |
| NOL (θ₂) | 0.0013 | 0.0022 | 0.0013 |
| (NOL(θ₂) − NOL(θ₁))/ | −0.0025 | −0.0046 | −0.0237 |
| (sin(θ₂) − sin(θ₁)) | | | |

The data show that NOL(θ_{mid}) increases with increasing surface roughness. Furthermore, the dependence of NOL from the propagation angle is such that smaller propagation angles are associated with greater NOL. The dependence of NOL from the propagation angle increases with increasing surface roughness as indicated by the increased negative slope determined by the formula

$$\frac{NOL ( {θ}_{2} ) - NOL ( {θ}_{1} )}{sin ( {θ}_{2} ) - sin ( {θ}_{1} )} .$$

### 2. Examples D and E

Examples D and E are glass articles comprising a glass having a glass composition 2. The refractive index n at a wavelength of 450 nm was about 1.98.

Examples D and E differ from each other with respect to the amount of sub-surface damages (SSDs) as shown in the following table.

| | |
|---|---|
| Example D | Example E |

| | | | | |
|---|---|---|---|---|
| Article thickness | 325 | μm | 325 | μm |
| Article diameter | 150 | mm | 150 | mm |

| | | |
|---|---|---|
| SSDs | many | reduced |

Optical loss of articles D and E was determined using the Prism Coupler Tool “Metricon” (see also FIG. 1) as described above with respect to Examples A to C.

The optical loss α was experimentally determined based on the measurements as indicated above for five different propagation angles, wherein the sinus of the different propagation angles was in a range of from >0.7 to <1.0. The normalized optical loss NOL was determined by multiplying the optical loss α with the article thickness d. A linear fit was applied to the obtained data as shown in FIGS. 3D and 3E. NOL(θ₁), NOL(θ_{mid}) and NOL(O₂) were estimated based on the linear fit. The results are shown in the following table.

| | Example D | Example E |
|---|---|---|
| NOL (θ₁) | 0.0039 | 0.0043 |
| NOL (θ_{mid}) | 0.0062 | 0.0049 |
| NOL (θ₂) | 0.0076 | 0.0053 |
| (NOL(θ₂) − NOL(θ₁))/ | 0.0159 | 0.0043 |
| (sin(θ₂) − sin(θ₁)) | | |

The data show that NOL(θ_{mid}) increases with an increasing amount of SSDs. The dependence of NOL from the propagation angle is such that smaller propagation angles are associated with lower NOL. The dependence of NOL from the propagation angle increases with an increasing amount of SSDs as indicated by the greater positive slope of Example D as compared to Example E determined by the formula

$$\frac{NOL ( {θ}_{2} ) - NOL ( {θ}_{1} )}{sin ( {θ}_{2} ) - sin ( {θ}_{1} )} .$$

### 3. Examples F to I

Example F is a glass article comprising a glass having a glass composition 2. Examples G to I are glass articles comprising a glass having a glass composition 1. Examples F to I are planar glass wafers.

Examples F to I differ from each other in particular with respect to their surface roughness and/or SSDs as shown in the following table.

| | Example F | | Example G | | Example H | | Example I | |
|---|---|---|---|---|---|---|---|---|
| Article | 0.33 | mm | 0.62 | mm | 0.33 | mm | 0.36 | mm |
| thickness | | | | | | | | |
| Article | 200 | mm | 150 | mm | 150 | mm | 150 | mm |
| diameter | | | | | | | | |
| TTV | <1 | μm | <1 | μm | <1 | μm | <1 | μm |
| Surface | 0.5 | nm | 3.7 | nm | 0.5 | nm | 1.1 | nm |
| roughness | | | | | | | | |
| RMS | | | | | | | | |

| | | | | |
|---|---|---|---|---|
| SSDs | many | no | no | no |

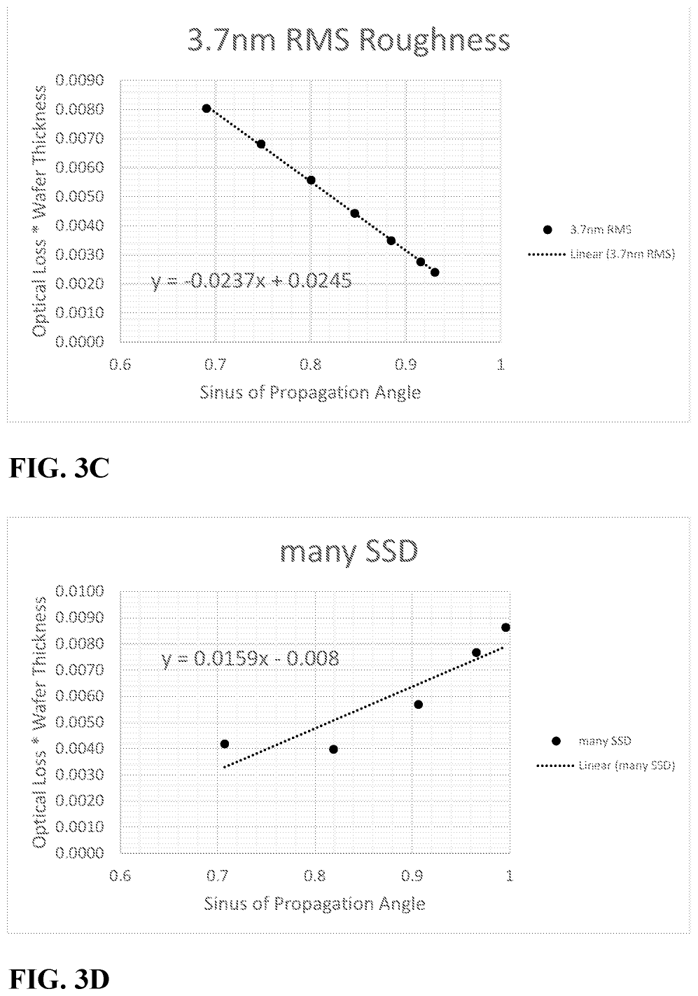

Light intensity curves showing the dependence of light intensity or the natural logarithm thereof from the lateral path position have been generated using the Prism Coupler Tool “Metricon”, Model 2010/M with prism type 200-P-2 and with waveguide loss measurement option as described above (see also FIG. 1). The resulting light intensity curves of examples F to I are shown in FIGS. 4 to 7, respectively. In Examples F and G, the periodicity includes alternating principal local maxima and secondary local maxima, in particular for propagation angles between 65° and 80°.

Referring now to the drawings, FIG. 1 shows a setup that may be used for determining the optical loss α. Light 1 is fed into the glass article 3 via a prism 2. The light is propagating through the inside of glass article based on total internal reflection at the main surfaces 4 and 5 of the article 3. The light is propagating at a propagation angle 6 formed between the normal (shown as dashed line) to the surface of the glass article and the propagation direction of the light approaching said surface. The light intensity is recorded at different positions by a detecting fiber 7a, 7b, 7c that is moved parallel to one of the two main surfaces (along main surface 4 in FIG. 1). The moving direction of the fiber is indicated by arrow 8. As indicated by the dotted lines, the detection angle and thus the intensity of detected light varies with the distance of the propagating light from the main surface 4. When the fiber is in a position such that the light propagating through the article is close to the second main surface 5, the detection angle is small and therefore the detected light intensity is low as well (see fiber 7a). In contrast, when the fiber is in a position such that the light propagating through the article is close to the main surface 4, the detection angle is large and therefore the detected light intensity is great as well (see fiber 7c). A middle position is indicated by fiber 7b.

FIG. 2 shows experimental results determined by the method shown in FIG. 1 for different propagation angles ranging from 45° to 85°. The x-axis shows the relative lateral position of the detecting fiber (in cm). The y-axis shows the natural logarithm of the detected intensity (arbitrary units). The data was arranged in a waterfall plot configuration in order to easy compare the linear slope of the different curves. The curves show that the intensity periodically increases and decreases depending on the distance of the light from the main surface of the glass article at which the detecting fiber is positioned. The respective frequency is dependent on the propagation angle (the smaller the propagation angle, the greater the frequency) and on the wafer thickness. Moreover, the detected intensity decreases with increasing lateral position of the detecting fiber. This is due to optical loss α upon propagation of the light through the glass article and can be used for determining the optical loss α by simply calculating the linear slope of the curve.

FIG. 3 shows the dependence of the normalized optical loss (NOL=optical loss α *thickness d of the glass article) on the y-axis from the sinus of the propagation angle on the x-axis for different glass articles.

FIGS. 3A to 3C show results for different samples of a glass 1 that differ from each other by the surface roughness. It can be seen that an increased surface roughness is associated with an increased normalized optical loss as indicated by an increased NOL(θ_{mid}). Furthermore, the dependence of the normalized optical loss from the propagation angle θ is increasing with increased surface roughness as indicated by the increased slope, which may be determined as

$$\frac{NOL ( {θ}_{2} ) - NOL ( {θ}_{1} )}{sin ( {θ}_{2} ) - sin ( {θ}_{1} )} ,$$

with θ₂ being a propagation angle with sin(θ₂)=0.98 and θ₁ being a propagation angle with sin(θ₁)=0.75.

FIGS. 3D and 3E show the results for different samples of a glass 2 that differ from each other by the amount of sub-surface damages (SSDs). An increased amount of SSDs results in increased absolute values of normalized optical loss as indicated by an increased NOL(θ_{mid}) in FIGS. 3D and 3E. The dependence of the normalized optical loss from the propagation angle θ is increasing with increased SSDs as indicated by the increased slope, which may be determined as

$$\frac{NOL ( {θ}_{2} ) - NOL ( {θ}_{1} )}{sin ( {θ}_{2} ) - sin ( {θ}_{1} )} ,$$

with θ₂ being a propagation angle with sin(θ₂)=0.98 and θ₁ being a propagation angle with sin(θ₁)=0.75. However, contrary to the influence of surface roughness described above, SSDs result in a positive slope, i.e. the normalized optical loss increases with increasing propagation angles.

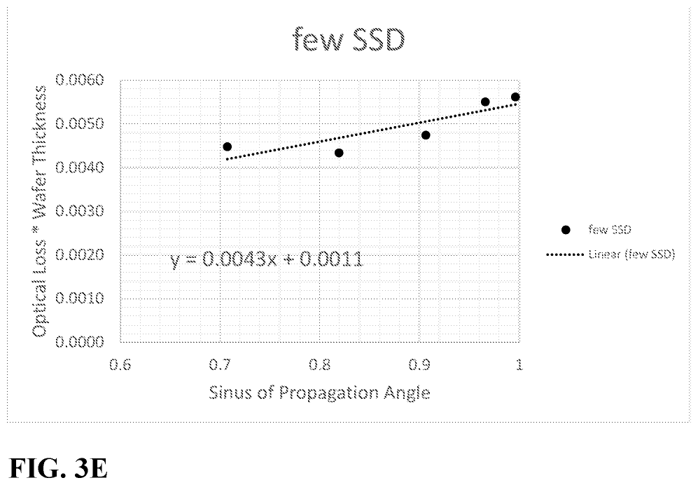

FIGS. 4 to 7 show experimental results determined by the method shown in FIG. 1 for different propagation angles. The x-axis shows the relative lateral position of the detecting fiber (in cm). The y-axis shows the natural logarithm of the detected intensity (arbitrary units). The curves show that the intensity periodically increases and decreases depending on the distance of the light from the main surface of the glass article at which the detecting fiber is positioned. In FIGS. 4 and 5, the periodicity includes alternating principal local maxima (higher intensity peaks) and secondary local maxima (lower intensity peaks), in particular for propagation angles between 65° and 80°.

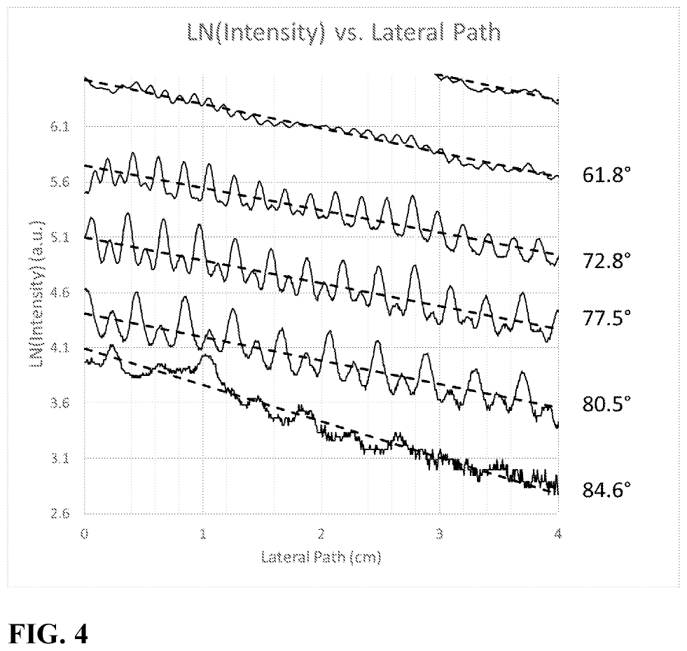

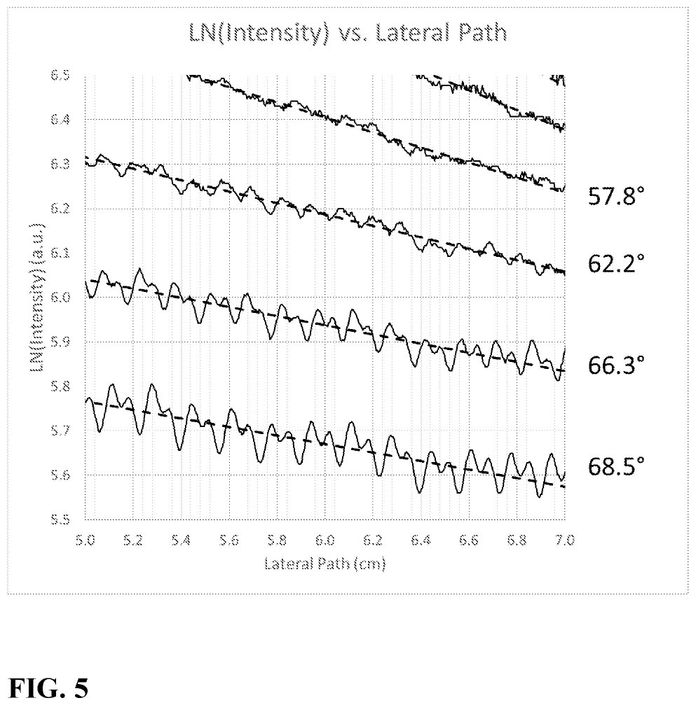

FIG. 4 shows the results of example F. FIG. 5 shows the results of example G. FIG. 6 shows the results of example H. FIG. 7 shows the results of example I.

FIG. 8 shows that the observed periodicity can be explained as a sum (superposition) of two sinus functions, Function 1 having y=A*sin(x) and Function 2 having y=B*sin(2x). Functions 1 and 2 have been chosen in FIG. 8 such that A=B. The superposition shows principal local maxima at positions at which both Function 1 and Function 2 have a local maximum. The superposition shows secondary local maxima at positions at which Function 1 has a minimum and Function 2 has a maximum.

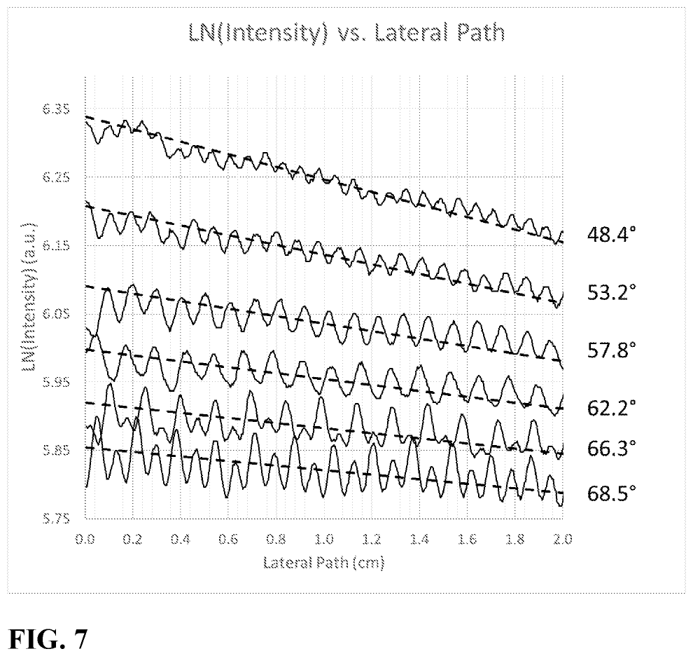

FIG. 9 shows a superposition of two sinus functions including a decay.

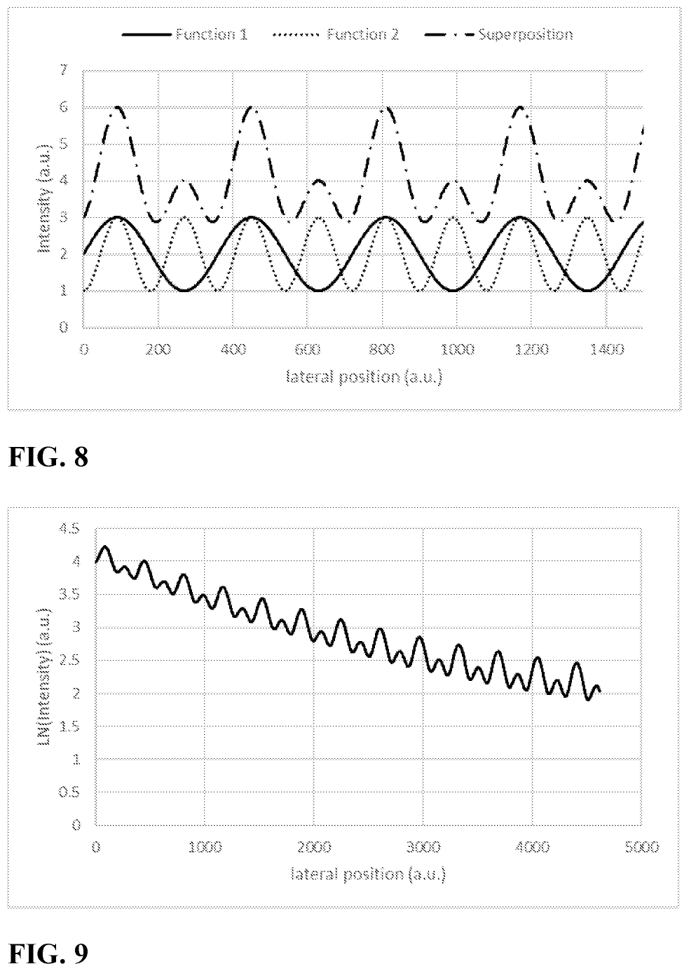

FIG. 10 shows an enlarged part of the curve of FIG. 9 for illustration of principal local maxima (11) and secondary local maxima (12). Aₙ indicates the height of a principal local maximum and Aₙ₊₁ indicates of the height of the corresponding secondary local maximum.

FIG. 11 shows a setup of FIG. 1. Light 1 is fed into the glass article 3 via a prism 2. When the fiber is in a position such that the light propagating through the article is close to the main surface 4, the detection angle is large and therefore the detected light intensity is great as well (see fibers 7c, 7d). Local maxima of light intensity are detected at the respective lateral path positions of the detecting fiber 7c, 7d. The distance of the lateral path positions corresponding to the respective maxima is indicated as Δx. Such maxima are termed “principal local maxima”. FIG. 11 illustrates that the distance Δx between two principal local maxima can be determined based on the propagation angle θ (reference sign 6) and the thickness t of the article. FIG. 11 identifies a right triangle including legs Δx/2 and t as well as angle 6. It follows that

$$tan ( ϑ ) = \frac{Δ x / 2}{t} so that Δ x = 2 * t * tan ( θ ) .$$

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### LIST OF REFERENCE SIGNS

1 Light
2 Prism
3 Glass article
4 First main surface of the glass article
5 Second main surface of the glass article
6a Angle of incidence (AOI) β
6b Angle ω between the prism's base and the side where the beam enters the prism
6 Propagation angle
7a, 7b, 7c, 7d Detecting fiber
8 Moving direction of the fiber
11 Principal local maxima
12 Secondary local maxima

What is claimed is:

1. A glass article, comprising:
a glass having a fracture toughness K_{Ic} of more than 0.4 MPa·√m;
wherein the glass article has an article thickness d, wherein the glass article is characterized by an optical loss α upon propagation of light having a wavelength of 450 nm inside the glass article based on total internal reflection at a propagation angle θ formed between a normal to a surface of the glass article and a propagation direction of the light approaching the surface;
wherein the optical loss α is determined by moving an optical fiber across the surface of the glass article in a direction of the propagating light beam and along the way detecting the light which was scattered and thereby left the glass article at different lateral path positions xᵢ of the optical fiber over a lateral path distance of the optical fiber of at least 2 cm, wherein the optical loss α is determined by the formula
$$α = \frac{ln ( {I}_{2} ) - ln ( {I}_{1} )}{{OP}_{2} - {OP}_{1}} ;$$
wherein I₂ and I₁ are light intensities at lateral path positions x₂ and x₁, respectively, of the optical fiber determined based on ln(I₂)=f(x₂) and ln(I₁)=f(x₁), respectively, with f(x) being the least squares linear regression describing the dependence of the natural logarithm of the detected light intensity from the lateral path position x of the optical fiber;
wherein OP₂ and OP₁ are optical path positions corresponding to the lateral path positions x₂ and x₁, respectively, with OP₂ and OP₁ determined as OP₂=x₂/sin(θ) and OP₁=x₁/sin(θ), respectively;
wherein a product a*d of optical loss α (in 1/cm) and article thickness d (in cm) is defined as normalized optical loss NOL;
wherein at a propagation angle ° mid the normalized optical loss NOL(θ_{mid}) is smaller than 0.02, wherein sin(θ_{mid})=0.83;
wherein a dependence of the normalized optical loss NOL from the propagation angle θ is such that
$$- 0.03 \leq \frac{NOL ( {θ}_{2} ) - NOL ( {θ}_{1} )}{sin ( {θ}_{2} ) - sin ( {θ}_{1} )} \leq 0.03 ,$$
wherein θ₂ is a propagation angle with sin(θ₂)=0.98 and θ₁ is a propagation angle with sin(θ₁)=0.75.

2. The glass article of claim 1, wherein the glass article is a glass wafer.

3. The glass article of claim 1, wherein the glass article has a thickness of from 0.10 mm to 2.0 mm.

4. The glass article of claim 1, wherein the glass article has a diameter of from 100 mm to 500 mm.

5. The glass article of claim 1, wherein the glass article has a warp of less than 100 μm.

6. The glass article of claim 1, wherein a refractive index n of the glass at a wavelength of 450 nm is in a range of from 1.45 to 2.45.

7. The glass article of claim 1, wherein a total thickness variation (TTV) of the glass article is less than 2 μm.

8. The glass article of claim 1, wherein the glass article has a surface roughness R_{q} in a range of from 0.1 nm to 5 nm.

9. The glass article of claim 1, wherein the glass article is characterized by absence of a secondary local maximum having a height Aₙ₊₁ which is more than 50% of a height Aₙ of a corresponding principal local maximum for any sequence maxₙ−minₙ−maxₙ₊₁ with x(maxₙ)>0.4 cm and with x(maxₙ₊₁)<2.0 cm in a logarithmic light intensity curve for at least one propagation angle θ in a range of from 65° to 80°.

10. The glass article of claim 1, wherein a Knoop hardness Hk of the glass is in a range of from 2 GPa to 10 GPa.

11. The glass article of claim 1, wherein a Young's modulus of the glass is in a range of from 60 GPa to 160 GPa.

12. A glass article having a thickness t, the glass article comprising:
a glass having a fracture toughness K_{Ic} of more than 0.4 MPa·√m;
wherein the glass article is characterized by a course of light intensity upon propagation of light having a wavelength of 450 nm inside the glass article based on total internal reflection at a propagation angle θ formed between a normal to a surface of the glass article and a propagation direction of the light approaching the surface;
wherein the course of light intensity is determined by moving an optical fiber across the surface of the glass article in a direction of the propagating light beam and along the way detecting the light which was scattered and thereby left the glass article at different lateral path positions xᵢ of the optical fiber over a lateral path distance of the optical fiber of at least 2 cm;
wherein the course of light intensity is characterized by a plurality of alternating local maxima (max) and local minima (min) in a logarithmic light intensity curve showing the natural logarithm of the light intensity detected by the optical fiber on the y-axis and the corresponding lateral path position xᵢ of the optical fiber on the x-axis;
wherein the logarithmic light intensity curve comprises a plurality of periodically occurring principal local maxima characterized by a distance between the lateral path positions of two neighboring principal local maxima being equal to 2*t*tan(θ)±100 μm;
wherein the logarithmic light intensity curve comprises a plurality of sequences maxₙ−minₙ−maxₙ₊₁ of a local minimum minₙ located between two local maxima maxₙ and maxₙ₊₁ at corresponding lateral path positions x(maxₙ)<x(minₙ)<x(maxₙ₊₁);
wherein I(maxₙ), I(minₙ) and I(maxₙ₊₁) are the light intensities at lateral path positions x(maxₙ), x(minₙ) and x(maxₙ₊₁), respectively;
wherein a height Aₙ of a first local maximum maxₙ is defined as ln(I(maxₙ))−ln(I(minₙ));
wherein a height Aₙ₊₁ of a second local maximum maxₙ₊₁ is defined as ln(I(maxₙ₊₁))−ln(I(minₙ));
wherein An>Aₙ₊₁;
wherein maxₙ is a principal local maximum;
wherein maxₙ₊₁ is a principal local maximum provided that a difference x(maxₙ₊₁)−x(maxₙ)=2*t*tan(θ)±100 μm;
wherein maxₙ₊₁ is a secondary local maximum provided that the difference x(maxₙ₊₁)−x(maxₙ) 2*t*tan(θ)±100 μm;
wherein the glass article is characterized by absence of a secondary local maximum having a height Aₙ₊₁ which is more than z % of the height Aₙ of the corresponding principal local maximum for any sequence maxₙ−minₙ−maxₙ₊₁ with x(maxₙ)>0.4 cm and with x(maxₙ₊₁)<2.0 cm in a logarithmic light intensity curve for at least one propagation angle θ in a range of from 65° to 80°, wherein z %=50%.

13. The glass article of claim 12, wherein the glass article is a glass wafer.

14. The glass article of claim 12, wherein the glass article has a thickness t of from 0.10 mm to 2.0 mm.

15. The glass article of claim 12, wherein the glass article has a diameter of from 100 mm to 500 mm.

16. The glass article of claim 12, wherein the glass article has a warp of less than 100 μm.

17. The glass article of claim 12, wherein a refractive index n of the glass at a wavelength of 450 nm is in a range of from 1.45 to 2.45.

18. The glass article of claim 12, wherein a total thickness variation (TTV) of the glass article is less than 2 μm.

19. The glass article of claim 12, wherein the glass article has a surface roughness R_{q} in a range of from 0.1 nm to 5 nm.

20. The glass article of claim 12, wherein the glass article is characterized by absence of a secondary local maximum having a height Aₙ₊₁ with Aₙ₊1>z %*An*(325 μm/t), provided that t>325 μm, for any sequence maxₙ−minₙ−maxₙ₊₁ with x(maxₙ)>0.4 cm and with x(maxₙ₊₁)<2.0 cm in the logarithmic light intensity curve for at least one propagation angle θ in a range of from 65° to 80°.
